(19) United States
(12) Patent Application Publication
(10) Pub. No.: US 2007/0230390 A1
(43) Pub. Date: Oct. 4, 2007

(54) Wireless communication apparatus

(76) Inventors: Yukihiro Takatani, Sagamihara (JP); Masayuki Ishizaki, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/605,996

(22) Filed: Nov. 30, 2006

(30) Foreign Application Priority Data
Mar. 28, 2006 (JP) 2006-087838

(51) Int. Cl. H04J 3/08

(52) U.S. Cl. 370/315

(57) ABSTRACT

The number of wasteful attempts at wireless data transmission to any wireless terminal with which communication is impossible is to be reduced. The wireless terminal constantly monitors the state of communication between wireless terminals and, when any change in the state of communication is found, one set or plural sets of data awaiting wireless transmission are checked to see whether or not they are destined for any wireless terminal with which communication is possible, the data being discarded if wireless communication is determined to be impossible. The number of wasteful attempts at wireless data transmission can be thereby reduced.

### CLAIM OF PRIORITY

The present application claims priority from Japanese patent application serial no. 2006-087803, filed on Mar. 28, 2006, the content of which is hereby incorporated by reference into this application.

### BACKGROUND OF THE INVENTION

The present invention relates to a wireless communication apparatus, and mote particularly to a wireless communication apparatus which can be suitably applied to a wireless communication network whose topology varies.

Japanese Patent Application Laid-Open No. 6-152650 discloses a communication apparatus which regularly monitors the transmission buffer of a packet transmission device, discards the packets which it holds from within the transmission buffer.

However, the technique disclosed by Japanese Patent Application Laid-Open No. 6-152650 is intended to prevent the capacity to process packet transmission from deterioration by discarding packets attributable to erroneous operation of the packet transmission device. Therefore, it is not an adequate technique for enhancing the performance of packet transmission processing in a system in which user terminals are connected wirelessly and the network topology constantly varies (ad hoc network).

An ad hoc network is a network which requires no centralized control and is configured of terminals among which wireless transmission and reception are possible. One of its major characteristics is a technique which enables terminals incapable of direct wireless communication with each other to achieve mutual communication by having plural other terminals capable of direct wireless communication relay the communication between them (multi-hop communication). An ad hoc network requires no base stations for the mobile telephone network or access points for a wireless LAN, and enables a network to be architected at low cost where no infrastructure is available. Therefore, it can serve effectively as simple means of network building in a limited area. By virtue of this advantage, the ad hoc network is now attracting interest also as technical means of establishing a communication network in an area which has suffered a natural disaster such as an earthquake, and whose base station has been deprived of its functions.

However, the currently available technology for ad hoc network architecture involves a number of unsolved technical problems. Since terminals constituting an ad hoc network perform wireless communication, their linking is less stable than in a wired network. As each terminal frequently enters into or severs from it, an ad hoc network also needs special security techniques, different from those for a wired network. Here, a problem is posed of how to dynamically detect an efficient and stable route in such an environment.

### SUMMARY OF THE INVENTION

The present invention by provides a wireless communication apparatus for use in a network, to simplify and improve the quality of communication to solve the problem noted above.

The problem can be solved by a wireless communication apparatus including a wireless unit that transmits and receives wireless signals including packets; a wireless connection establishing unit that determines establishment or severance of wireless connection with another wireless communication apparatus arranged within the reach of wireless signals; a routing information generating unit that generates transfer routing information for packets; and a packet transmission queue that holds queues containing forwarding MAC addresses, further provided with an intra-queue packet control unit that, when the wireless connection establishing unit has determined the severance of wireless connection, searches for the presence or absence of any queue which is held by the packet transmission queue and of which the wireless connection is to be severed.

The problem can also be solved by a wireless communication apparatus including a wireless unit that transmits and receives wireless signals including packets; a wireless connection establishing unit that determines establishment or severance of wireless connection with another wireless communication apparatus arranged within the reach of wireless signals; a routing information generating unit that generates transfer routing information for packets; and a packet transmission queue that holds queues containing forwarding MAC addresses, further provided with an intra-queue packet control unit that, when the wireless connection establishing unit has determined the severance of wireless connection, deletes any queue which is held by the packet transmission queue and of which the wireless connection is to be severed, the routing information generating unit updating the transfer routing information.

The problem can also be solved by a wireless communication apparatus including a wireless unit that transmits and receives wireless signals including packets; a wireless connection establishing unit that determines establishment or severance of wireless connection with another wireless communication apparatus arranged within the reach of wireless signals; a routing information generating unit that generates transfer routing information for packets; and a packet transmission queue that holds queues containing forwarding MAC addresses, further provided with an intra-queue packet control unit that, when the wireless connection establishing unit has determined the severance of wireless connection, updates on the basis of updated transfer routing information the forwarding MAC address of any queue which is held by the packet transmission queue and of which the wireless connection is to be severed, the routing information generating unit updating the transfer routing information.

The problem can also be solved by a wireless communication apparatus including a wireless unit that transmits and receives wireless signals including packets; a wireless connection establishing unit that determines establishment or severance of wireless connection with another wireless communication apparatus arranged within the reach of wireless signals; a routing information generating unit that generates transfer routing information for packets; and a packet transmission queue that holds queues containing forwarding MAC addresses, further provided with an intra-queue packet control unit that, when the wireless connection establishing unit has determined the severance of wireless connection, updates the forwarding MAC address of any queue which is held by the packet transmission queue and of which the wireless connection is to be severed into a MAC address for which wireless connection is established, the routing information generating unit updating the transfer routing information.

The problem can also be solved by a wireless communication apparatus including a wireless unit that transmits and receives wireless signals including packets; a wireless connection establishing unit that determines establishment or severance of wireless connection with another wireless communication apparatus arranged within the reach of wireless signals; a routing information generating unit that generates transfer routing information for packets; and a packet transmission queue that holds queues containing forwarding MAC addresses, wherein the upper limit of retransmission attempts of the packet whose destination is a severed wireless terminal held by the packet transmission queue is reduced when the wireless connection establishing unit has determined the severance of wireless connection.

The problem can also be solved by a wireless communication apparatus including a central processing unit connected by a bus; a control memory into which plural programs are written; a network controller; a FIFO memory that holds transmission queues each containing transfer MAC addresses and destination IP addresses; and a wireless LAN unit connected to the network controller, wherein, when severance of the link with another wireless communication apparatus has been detected, the FIFO memory is searched with the IP address of the other wireless communication apparatus as a key, and any queue destined for the other wireless communication apparatus is discarded or updated.

The problem can also be solved by a wireless communication apparatus including a central processing unit connected by a bus; a memory; a network controller; and a wireless LAN unit connected to the network controller, wherein the memory has a control area in which plural programs are written; and a FIFO area that holds transmission queues each containing transfer MAC addresses and destination IP addresses, and when severance of a link with another wireless communication apparatus has been detected, the FIFO area is searched with the IP address of the other wireless communication apparatus as a key, and any queue destined for the other wireless communication apparatus is discarded or updated.

### BRIEF DESCRIPTION OF THE DRAWINGS

Preferred embodiments of the present invention will now be described in conjunction with the accompanying drawings, in which;

FIG. 1 illustrates a network topology (topology 1);

FIG. 2 illustrates another network topology (topology 2);

FIG. 3 illustrates still another network topology (topology 3);

FIG. 4 illustrates a HELLO message transmitted by node A (part 1);

FIG. 5 illustrates a HELLO message transmitted by node B;

FIG. 6 illustrates the HELLO message transmitted by node A (part 2);

FIG. 7 illustrates the hierarchical structure of a communication protocol and the flow of data transmission;

FIG. 8 lists the IP addresses and the MAC addresses of nodes;

FIG. 9 is a routing table of node A;

FIG. 10 is an ARP table of node A;

FIG. 11 is another routing table of node A;

FIG. 12 illustrates the transmission queue of node A immediately after the link between node A and node B is severed;

FIG. 13 illustrates the transmission queue of node A after rerouting is accomplished;

FIG. 14 is a flowchart of operations to process packet transmission;

FIG. 15 is a functional block diagram of a node;

FIG. 16 is a hardware block diagram of the node;

FIG. 17 is a link establishment table of node A of topology 1;

FIG. 18 is a link establishment table of node A of topology 3;

FIG. 19 is a flowchart of processing of packet discarding;

FIG. 20 illustrates the transmission queue of node A after the processing of packet discarding;

FIG. 21 is a flowchart of rerouting;

FIG. 22 illustrates the transmission queue of node A after the rerouting;

FIG. 23 is a flowchart of rerouting;

FIG. 24 illustrates still another network topology (topology 4);

FIG. 25 is a link establishment table of node A of topology 4;

FIG. 26 illustrates still another network topology (topology 5);

FIG. 27 illustrates still another network topology (topology 6);

FIG. 28 is a link establishment table of node A of topology 6;

FIG. 29 is a flowchart of rerouting;

FIG. 30 illustrates a table of the number of retransmission attempts;

FIG. 31 is a flowchart of updating the number of retransmission attempts at the time of link establishment;

FIG. 32 is a flowchart of updating the number of retransmission attempts at the time of link severance;

FIG. 33 illustrates another table of the number of retransmission attempts; and

FIG. 34 is a flowchart of operations to process packet transmission.

### DESCRIPTION OF THE PREFERRED EMBODIMENTS

Preferred embodiments of the present invention will be described below with reference to the accompanying drawings. Here, the routing protocol and the method of monitoring the state of linking between terminals (hereinafter referred to as nodes) in the ad hoc network will be first described.

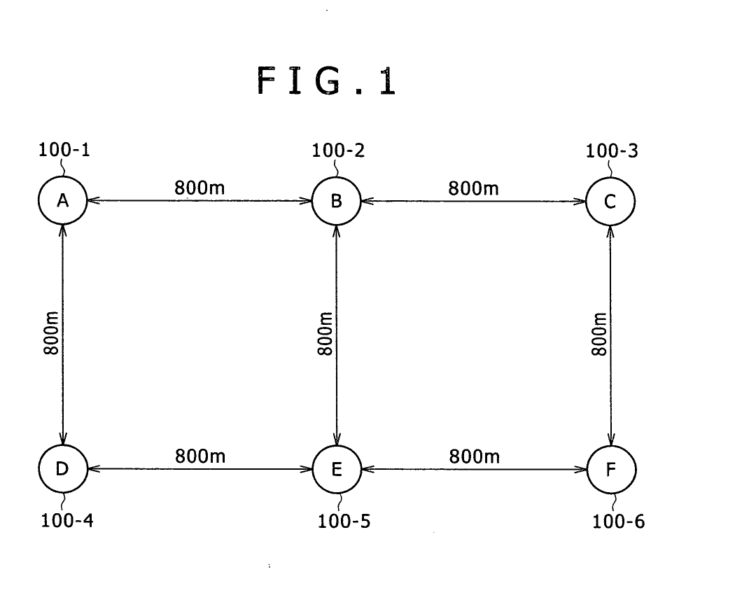

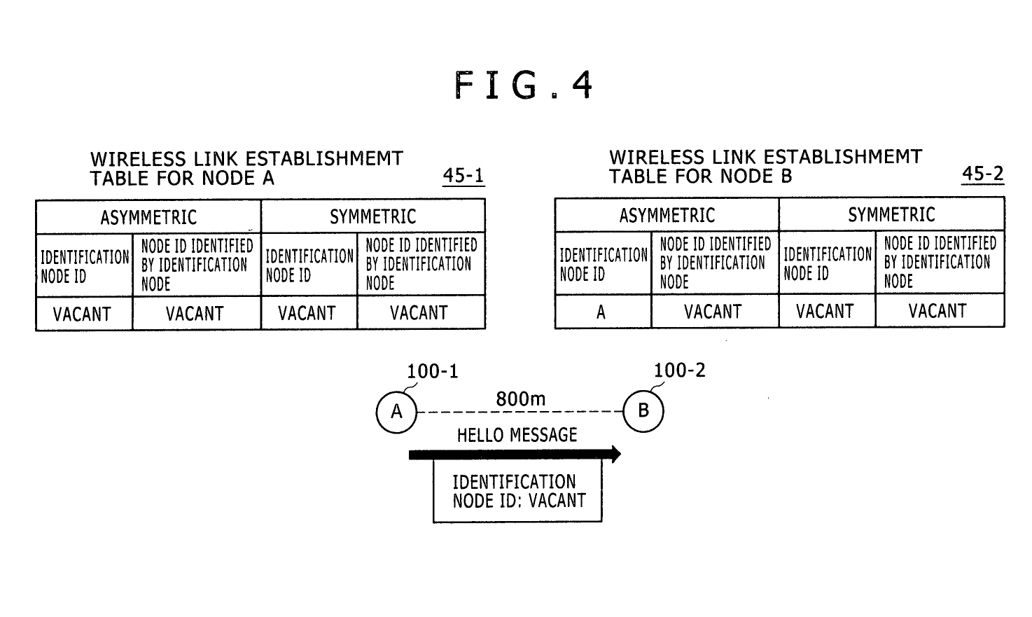

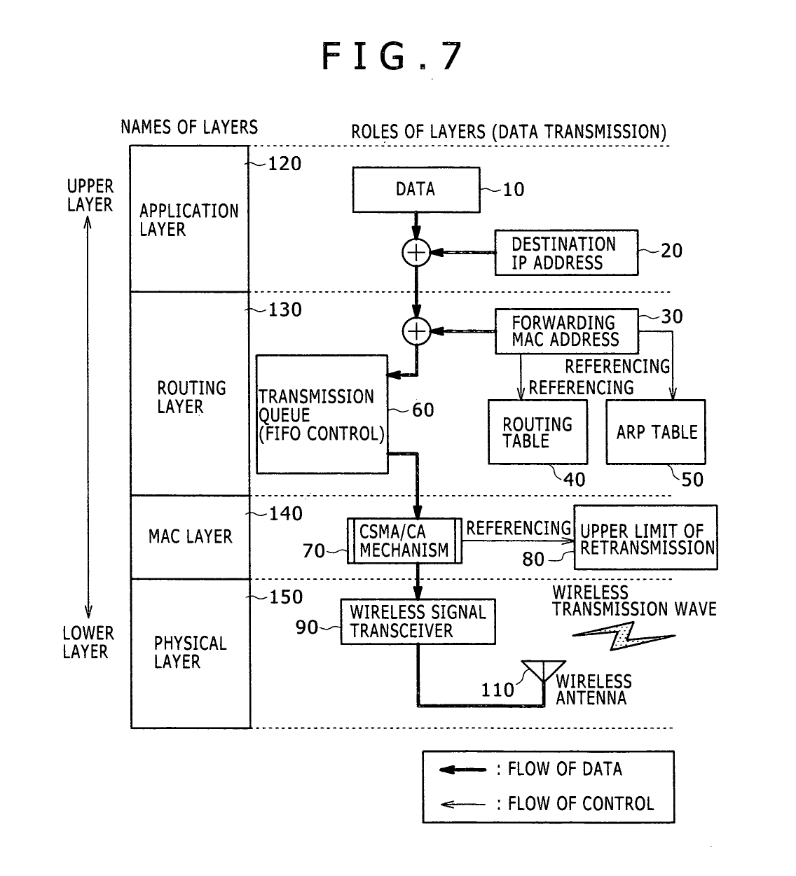

First, the routing protocol will be described with reference to FIG. 1 through FIG. 7. FIG. 1 through FIG. 3 illustrate network topologies. FIG. 4 through FIG. 6 illustrate HELLO messages FIG. 7 illustrates the hierarchical structure of a communication protocol and the flow of data transmission.

Shifting of any node in a network varies the arrangement of nodes (hereinafter referred to as network topology) and gives rise to an entry into or severance from the network. For this reason, routing of transferring data from one node to another varies over time. To adapt to those variations in network topology, the routing protocol causes routing information to be exchanged among the nodes in the network as appropriate to update the routing information. The performance of each node, the preconditions for the operation of the routing protocol, and specific examples of network topology and rerouting operation will be described below with reference to drawings.

The performance of each node and the preconditions for the operation of the routing protocol will now be described. Incidentally, these preconditions are common among the preferred embodiments to be described below. A node, mounted with a wireless communication apparatus capable of transmission and reception, can shift its position. The maximum reach of wireless communication is supposed to be 1 km. The routing protocol so reroutes the aforementioned multi-hop communication as to minimize the number of relaying terminals (including 0). Hereinafter the number of relays in the multi-hop communication will be referred to as the number of hops.

A network topology will be described with reference to FIG. 1. Referring to FIG. 1, in the network topology, each circular sign denotes a node 100, and the sign marked in this circle is the node ID. The nodes 100 are connected by bidirectional arrows. This indicates that the nodes linked by one or another of the arrows can perform direct wireless communication with each other. Hereinafter, a state in which direct wireless communication is bidirectionally possible will be referred to as a link-established state. Incidentally, the method of wireless link establishment accomplished between nodes will be described afterwards.

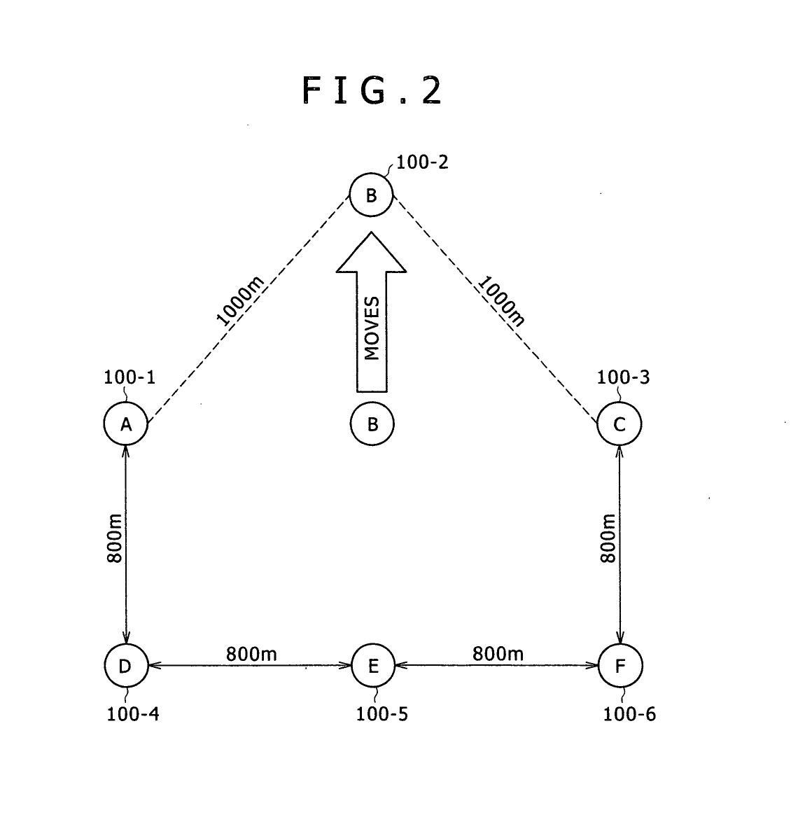

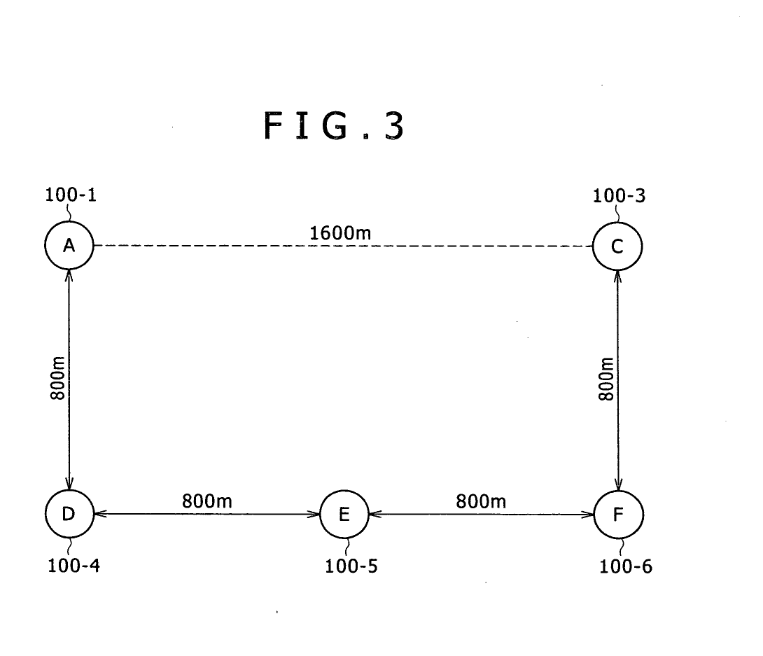

Hereupon, it is supposed that a data transfer is begun from node A to node C. In this case, node B is assigned as the relaying node by the routing protocol, and data is transferred by a route of node A→node B→node C. If, during this data transfer, node B moves to a position where it cannot communicate with either node A or node C as shown in FIG. 2 and a change to another network topology shown in FIG. 3 has taken place, the data transfer from node A to node C will be no longer possible by the route of node A→node B→node C. To add a supplementary description regarding FIG. 3, since the maximum distance of wireless communication between nodes is 1 km according to one of the preconditions and the distance between node A and node C is 1.6 km, no direct wireless communication is possible between them. Therefore, the routing protocol is constantly watching the state of links among nodes A, B and C; upon recognition of the severance of a link, it searches for new routes, and switches to the route which would involve the smallest number of hops among them. In the case shown in FIG. 3, there is only one route that enables data to be transferred from node A to node C, namely a route of node A→node D→node E→node F→node C. In this way, the routing protocol accomplishes rerouting.

Next, the means of monitoring the state of linking will be described with reference to the operations of Optimized Link State Routing (OLSR), which is ad hoc routing standardized by the Internet Engineering Task Force (IETF). In OLSR, control information known as a HELLO message is regularly transmitted to enable each node to recognize the presence of other nodes with which it can communicate. This information includes node IDs around recognized by the node intending communication and, when a HELLO message containing its own node ID is received from another node, so that the node can recognize possibility to bidirectionally communicate with the other node which is the origin of that HELLO message. Hereupon, link establishing operations will be described in terms of a case of two nodes, the minimum size of a network, with reference to FIG. 4 through FIG. 6.

To begin with, a state will be described in which a link is established between any of the nodes 100 with another node and a HELLO message is regularly transmitted from node A. Here in the state shown in FIG. 4, node A is exchanging a HELLO message with no other node. Therefore, a link establishment table 45-1 is vacant both in asymmetric and in symmetric directions. Then, all the node IDs stored in the asymmetric and symmetric identification node ID columns of the link establishment table 45-1 are stored in the identification node ID column of the HELLO message and transmitted. Incidentally, as the vacancy of the link establishment table 45-1 of node A is presupposed here, the identification node ID columns are vacant. The ID of the transmitting node (node A here) is attached here to the HELLO message. Node B having received the HELLO message from node A stores the node ID of node A and the node ID which node A has been able to recognize on the asymmetric side of its own link establishment table 45-2. The reason for the storing into the asymmetric side is that, since the ID of node B is stored in the identification node ID column of node A, it can be considered that node A does not recognize node B.

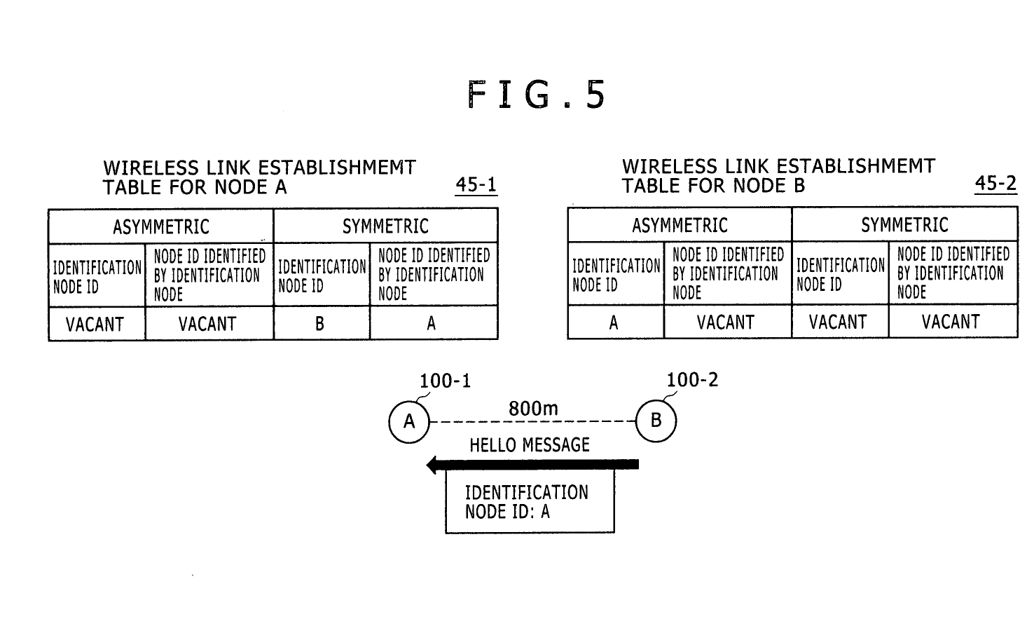

Referring now to FIG. 5, next, node B stores the node ID of node A into the identification node ID column and transmits a HELLO message. Having received this HELLO message, node A confirms its own node ID in the identification node ID column of the HELLO message, and stores, into the link establishment table (symmetric) 45-1 of node A, the node ID of node B and the node ID recognized by node B. At this point of time, node A recognizes successful establishment of a link with node B.

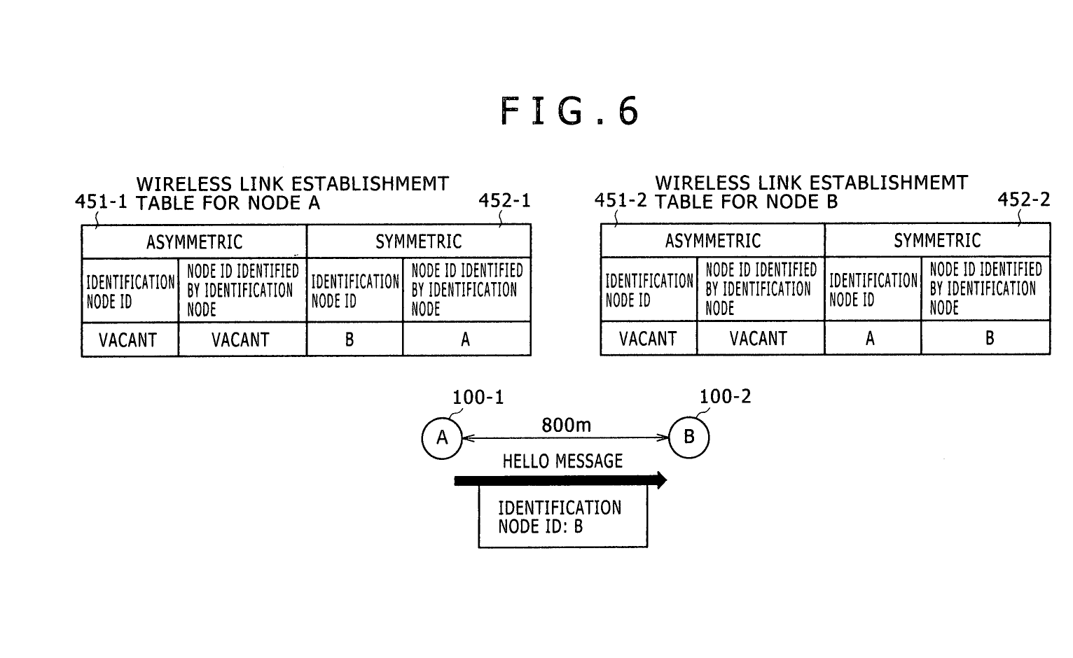

After that, now with reference to FIG. 6, node A stores the identification node ID of node B into a HELLO message and transmits it. Having received that message, as node B has been able to confirm its own node ID in the identification node ID column of the HELLO message, it transfers the ID of node A stored in the (asymmetric) column 451-2 of the link establishment table of node B to the (symmetric) column 452-2 of the link establishment table, and also transfers the node ID recognized by node A (B in this case) to the (symmetric) column 452-2 of the link establishment table. At this point of time, node B recognizes successful establishment of a link with node A. Mutual storing of the source node ID of a HELLO message each node has been able to receive into the identification node ID column of the HELLO message and notifying the other communicating node of the storage in this way, followed by confirmation of mutual recognition, constitutes link establishment.

Next will be described the procedure of link severance. The HELLO message used for recognizing link establishment is provided with timers. First, these timers will be described. The timing of timer starting is the point of time at which link establishment with each node to communicate with has been recognized, and a timer is allocated for each node. To describe it with reference to the foregoing description of the procedure of link establishment, it is the timing to start the timer when a node has successfully received from another node a HELLO message in which its own node ID is stored. If no HELLO message can be received for a certain period of time from a node with which a link was once established, the node ID of that node is deleted from the link establishment table, and the severance of the link with that node is recognized.

In this way, link establishment or link severance is recognized in OLSR by regularly transmitting a HELLO message.

Next, the hierarchical structure architected within the node to realize the communication protocol and the role of each layer will be described with reference to FIG. 7. To broadly analyze the hierarchical structure within the node into four levels, there are, from top to bottom, an application layer 120, a routing layer 130, a media access control (MAC) layer 140 and a physical layer 150. Now, the procedure of data transmission will be described while identifying the role of each layer.

First, data for FTP (TCP) and streaming-distributed data (UDP). 10 among others are generated in the application layer 120, and the IP address 20 of the destination node (hereinafter referred to as destination IP address) is assigned to each set of data 10, which is handed over to the routing layer.

In the routing layer 130, a routing table 40 generated and updated by the routing layer 130 is searched for the IP address 30 of the forwarding node matching the destination IP address (hereinafter referred to as forwarding IP address), a MAC address matching the forwarding IP address (hereinafter referred to as forwarding MAC address) 30 is assigned from an Address Resolution Protocol (ARP) table 50, and it is queued into a transmission queue 60 performing First In First Out (FIFO) control (the FIFO control) will be described afterwards. The aforementioned generation and updating of the routing table 40 requires means of collecting network topology information from the nodes in the network. This topology information collecting means constitutes one of major factors characterizing various commonly recognized routing protocols. However, since the topology information collecting means itself has no essential part in this embodiment, the following description will concern only the results of routing table generation and updating.

To continue the description of the procedure of data transmission, the MAC layer 140 takes out data from the transmission queue 60, and hands over the data to the physical layer 150 in accordance with the Carrier Sense Multiple Access/Collision Avoidance (CSMA/CA) mechanism 70. The physical layer 150 transmits the received data as a wireless transmission wave from a wireless signal transceiver 90via an antenna 110. The CSMA/CA mechanism and the upper limit of retransmission attempts 80 here will be described in connection with the later description of unicast transmission in the MAC layer.

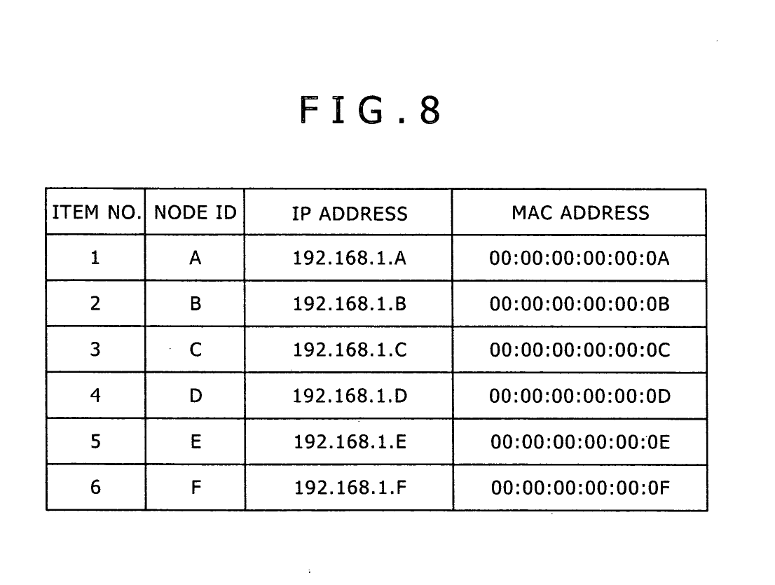

The method of determining the forwarding MAC address performed by the aforementioned routing layer will now be described. First, a list of the IP addresses and the MAC addresses of the nodes present in the network topology of FIG. 1 is shown in FIG. 8. FIG. 8 here is intended to help describe the IP addresses and the MAC addresses of nodes. Since FIG. 8 merely presents preconditions, no particular explanation of this list will be given.

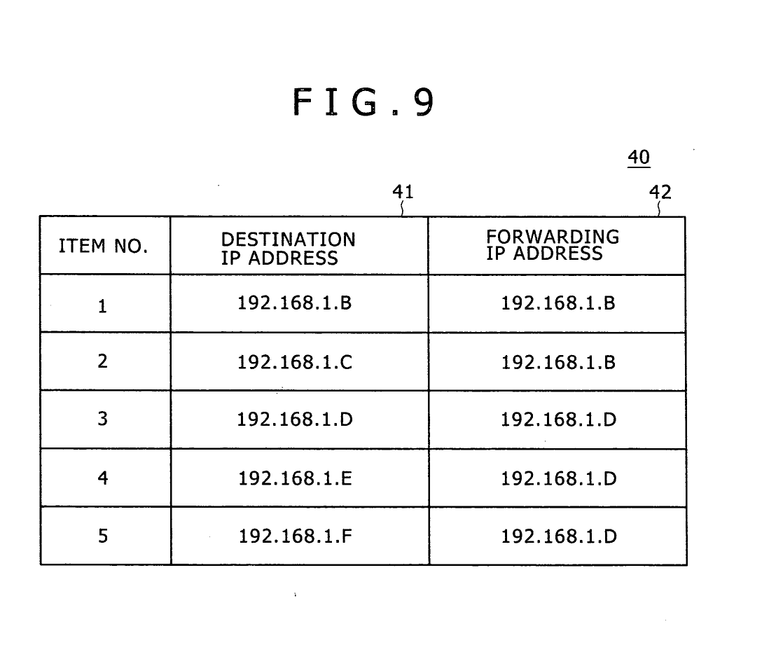

Next, the routing table and the ARP table of node A when link establishment has been completed within the network topology of FIG. 1 will be described with reference to FIG. 9 and FIG. 10. Here, FIG. 9 is the routing table and FIG. 10, the ARP table, of node A.

Referring to FIG. 9, the routing table 40 includes destination IP addresses 41 and forwarding IP addresses 42. From FIG. 9, node A transfers to node B data whose destination IP addresses are node B and node C. Node A also transfers to node D data whose destination IP addresses are node D, node E and node F.

Referring to FIG. 10, the ARP table 50 includes IP addresses 51 and MAC addresses 52. From FIG. 10, node A holds the matching between the IP addresses and the MAC addresses of its own and of node B and node D, which are the destinations of transfer.

As described with reference to FIG. 7, determination of a forwarding MAC address involves two steps including one of searching for the forwarding IP address and the other of searching for the forwarding MAC address according to the forwarding IP address thereby retrieved.

For item number 1 in the routing table 40 of FIG. 9, the IP address of the destination node when data is to be transferred to node B is “192.168.1.B”, which is the IP address of node B. On the other hand, item number 2 in the ARP table 50 of FIG. 10 indicates that the MAC address whose destination IP is “192.168.1.B” is “00:00:00:00:00:0B”. Thus with reference to the routing table 40 and the ARP table 50, the forwarding MAC address for a data transfer to node B is determined.

Similarly for item number 2 in the routing table 40 of FIG. 9, the forwarding IP address for a data transfer to node C is “192.168.1.B”. On the other hand, item number 2 in the ARP table 50 of FIG. 10 indicates that the MAC address whose destination IP is “192.168.1.B” is “00:00:00:00:00:0B”. The forwarding MAC address for data transfer to node B is determined in this procedure.

The difference between the foregoing two procedures of determining the forwarding MAC address is that, since node A can directly communicate with node B, the MAC address of node B is assigned to the forwarding MAC address for a transfer to node B, but in a transfer to node C the MAC address of node B, to be selected as the relaying node, is assigned because node A cannot directly communicate with node C. In this way in the routing layer, the forwarding MAC address is determined according to the destination IP address assigned to the data by the application layer and, after assigning it to the data, the data is queued into the transmission queue.

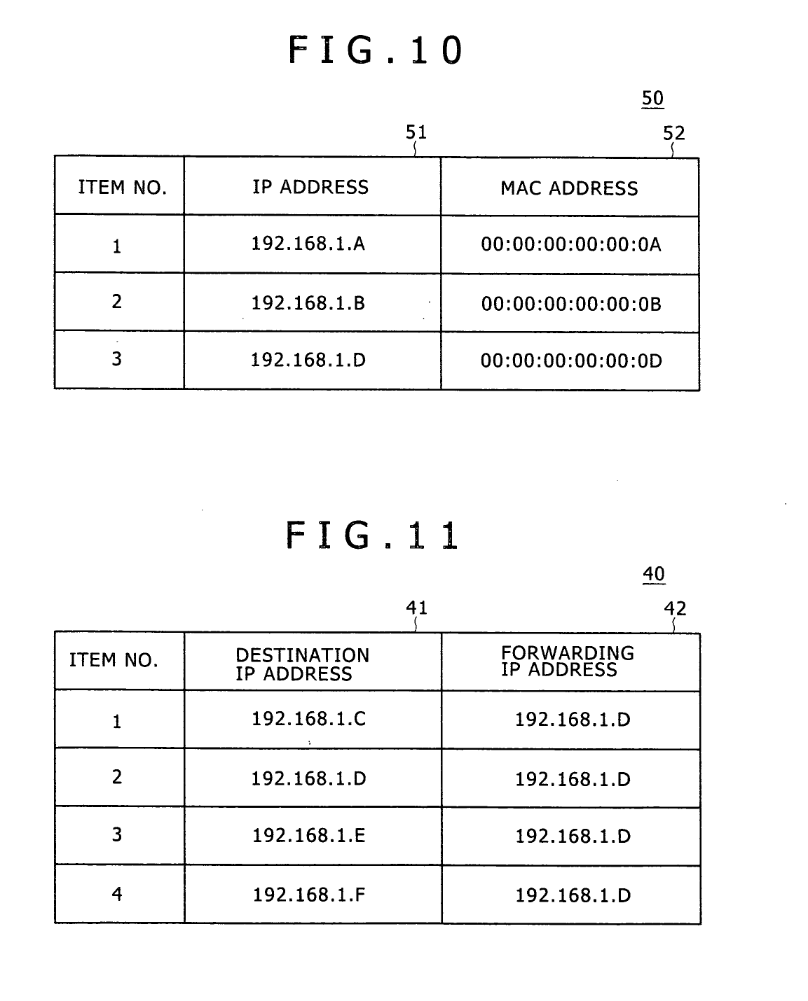

In the aforementioned routing table, when the network topology has varied from FIG. 1 to FIG. 3, the routing layer makes two alterations from FIG. 9 to FIG. 11. FIG. 11 here is the routing table of node A in the topology of FIG. 3.

The first alteration here is the deletion of the forwarding node B in item number 1 of FIG. 9 because it has severed from the network. The other alteration is that of the forwarding IP address from the IP address of node B to the IP address of node D in item number 2 of FIG. 9 because node B, which had relayed data transfers to node C until before the network topology varied, has severed from the network and rerouting to node A→node D→node E→node F→node C has taken place. Therefore in FIG. 11, the IP address of node B is deleted and the forwarding IP address 42 is node D in every case.

Next, to facilitate understanding of the subsequent description, unicast transmission by the CSMA/CA mechanism, which is the communication protocol of the MAC layer will be described. In an ad hoc network, since nodes can perform wireless transmission of data and are mobile, they are usually allowed to enter into or sever from the network as often as desired in a short period of time. For this reason, in the MAC layer of an ad hoc network, it is the common practice to use the CSMA/CA mechanism, which is intended to avoid collision of wireless transmission by having each node perform autonomous decentralized control. The description of this embodiment also presupposes the use of the CSMA/CA mechanism. In unicast transmission by the CSMA/CA mechanism, the data transmission side considers that data transmission has normally ended when it receives a reception acknowledging packet (hereinafter referred to as ACK) from the data receiving side. There is available an ACK reception awaiting timer on the data transmission side, where the same data is retransmitted upon a timeout and retries reception of the ACK. The upper limit of retransmission attempts is set for this data retransmission (denoted by reference numeral 80 in FIG. 7). If no ACK is received even after retransmission has been tried as many times as that upper limit of retransmission attempts, that set of data is discarded from the transmission queue, and transmission of the next set of data is tried in the same procedure.

First, the case of the topology shown in FIG. 2 described above will be considered. When node B is going out of the reach of wireless communication with node A in a situation when a data transfer from node A to node C and a data transfer from node A to node D are taking place at the same transmission rate within the same period, plural sets of data awaiting transmission to node B are queued into the transmission queue of node A. In the following description, it will be specifically supposed that the length of the transmission queue of each node is 50 and 10 sets of data on the average are queued in the transmission queue of node A during a data transfer period as data awaiting transmission. The reason for mentioning “on the average” here is that the number of sets of data awaiting transmission in a transmission queue varies with the situation of transmission from each node in the network.

Now, when node B has shifted outside the reach of wireless communication with node A as shown in FIG. 3, node A recognizes the severance of the link to node B in accordance with the aforementioned procedure of monitoring the state of linking. Then, node A reroutes the data transfer to node C from node A→node B→node C to node A→node D→node E→node F→node C. However, since data according to which the forwarding MAC address is the MAC address of node B is already queued in the transmission queue of node A, retransmission to node B, with which wireless communication is impossible, is repeated with respect of each of those sets of queuing data as many times as the aforementioned upper limit of retransmission attempts. Thus, already queued data is discarded without being transferred to node C, the start of a data transfer by a new route or the start of transmitting on a transfer route irrelevant to node B is unnecessarily delayed.

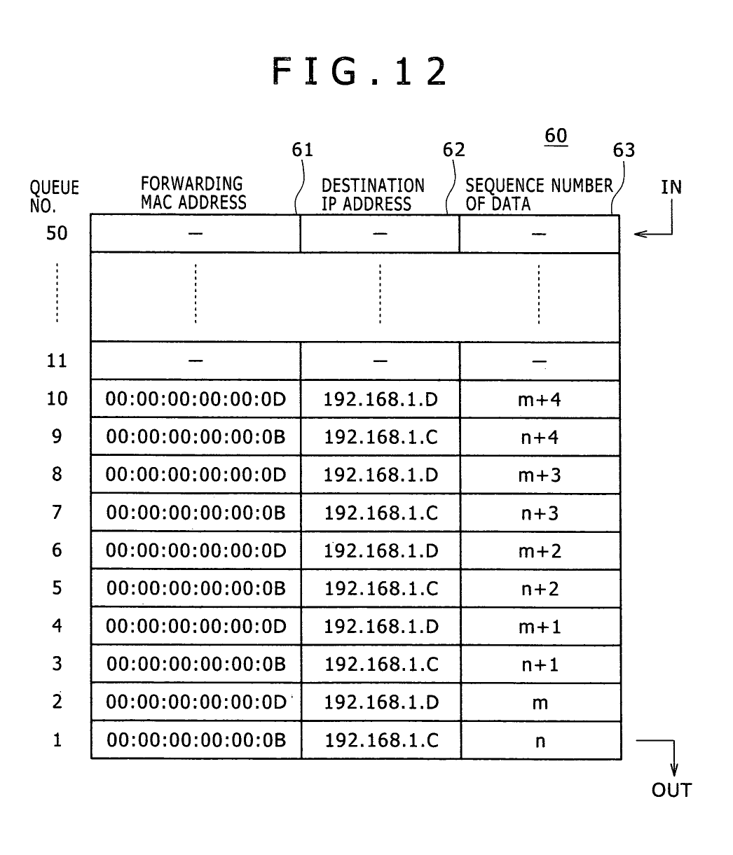

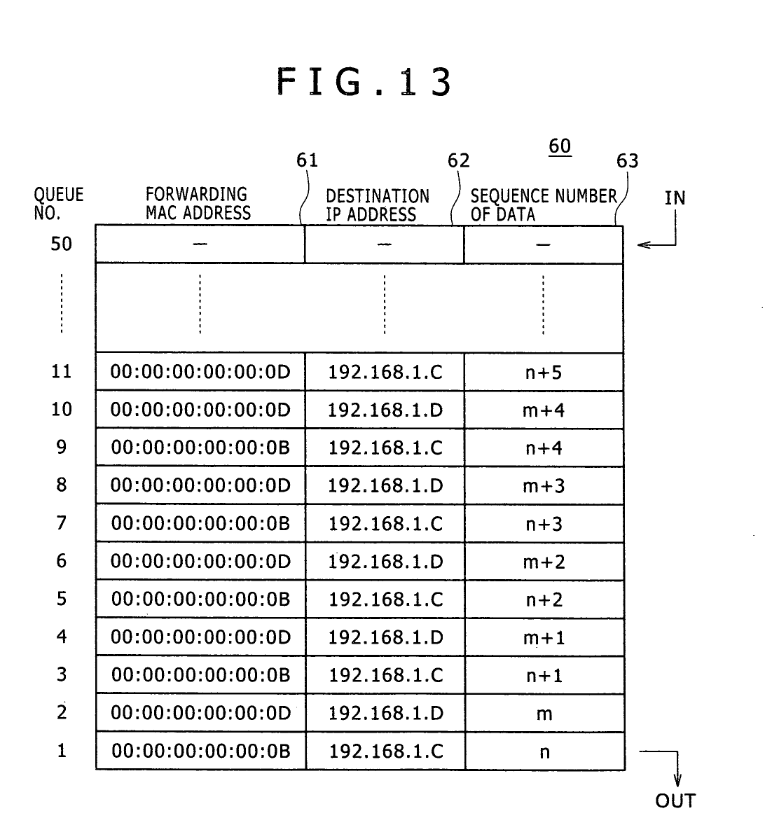

Now, the outline of operations of the transmission queue in the above-described situation will be described in more specific terms with reference to FIG. 12 and FIG. 13. Here FIG. 12 illustrates the transmission queue of node A immediately after the link between node A and node B is severed, and FIG. 13, the transmission queue of node A after rerouting is accomplished.

Here with reference to FIG. 12, the length of the transmission queue is 50 and 10 sets of data are queued therein. To describe the data in more detail, at 1, 3, 5, 7 and 9 in queue number, data of which the destination IP address 62 is the IP address of node C and the forwarding MAC address 61 is the MAC address of node B selected as the relaying node is queued. Similarly, at 2, 4, 6, 8 and 10 in queue number, data of which the destination IP address 62 is the IP address of node D and the forwarding MAC address 61, since node A and node D can directly communicate with each other, is the MAC address of node D is queued. Incidentally, the sequence numbers of data represent the sequence to the same destination IP address.

This transmission queue is under FIFO control, which is extensively used for traffic control. A simple way of FIFO control will be described below. Data inputting to the queue begins at queue number 50, and the inputted data is successively packed toward queue number 1. Data outputting from the queue begins at queue number 1, and the data queued at queue number 2 onward is shifted toward queue number 1. This control causes data generated by the application layer to be outputted in a sequence from older toward newer data.

To describe the operations of the transmission queue after link severance between node A and node B, based on this understanding of FIFO control, data outputted from the transmission queue and subjected to wireless transmission is that beginning with data of queue number 1. Referring to FIG. 13, data of sequence number (n+5) generated by the application layer after rerouting is accomplished in recognition of the link severance and handed over to the routing layer is queued at queue number 11 in the transmission queue. Therefore, until the data of sequence number (n+5) is outputted, transmission of 10 sets of data is awaited.

This phenomenon is witnessed particularly conspicuously in an ad hoc network wherein nodes can perform wireless transmission of data and are mobile, and enter into or sever from the network as often as desired in a short period of time. Further, while the foregoing description presupposes the setting of a wireless LAN, where an ad hoc network is built of a low speed wireless transmission system, not a high speed one like a wireless LAN, wasteful repetition of data retransmission would have an even greater impact on reducing the overall throughput of the system.

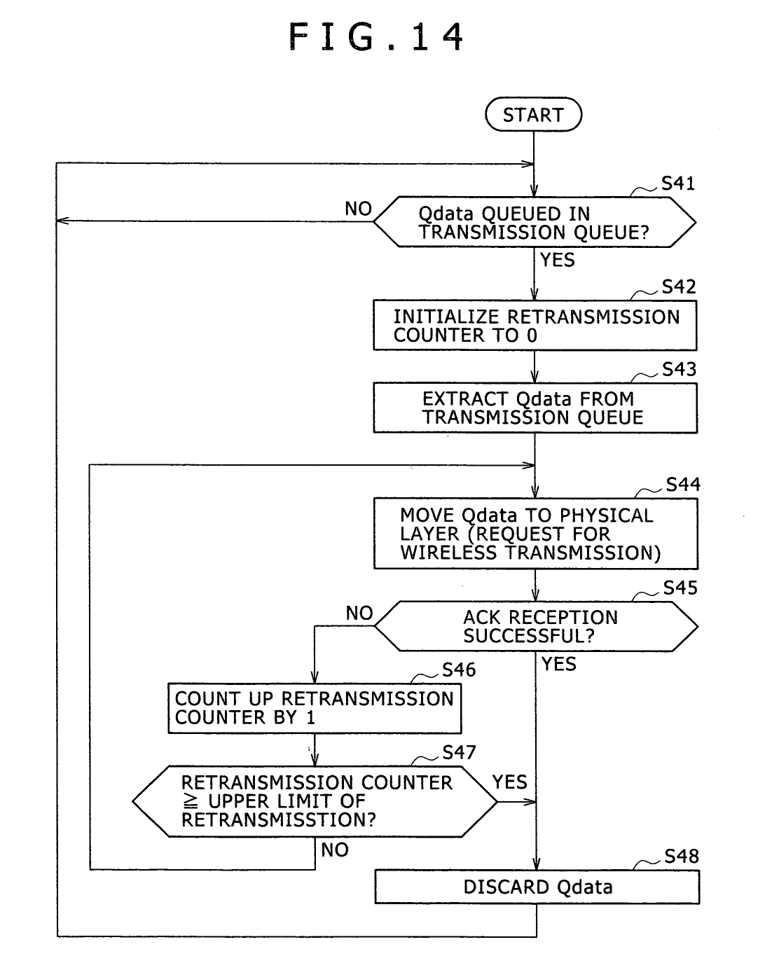

Next, the operations of packet transmission processing by the CSMA/CA mechanism will be described with reference to the flowchart of FIG. 14. FIG. 14 here is a flowchart of operations to process packet transmission. Referring to FIG. 14, first it is checked whether or not Qdata is queued in the transmission queue 60 (S41). If Qdata is found not queued at step 41 (NO), it means that there is no data to be transmitted, and therefore step 41 is repeated. If YES at step 41, a retransmission counter is initialized to 0 (S42). Next, Qdata is extracted from the transmission queue (S43), and the extracted Qdata is handed over to the physical layer 150 (S44). Then, as the physical layer 150 wirelessly transmits the Qdata to the opposite node, the transmitting node awaits ACK from the opposite node. Next, it is checked whether or not ACK has been successfully received (S45) and, if successful (YES), the processing branches out to step 48. If unsuccessful (NO), the processing branches out to step 46 to process retransmission. At step 46, the retransmission counter is incremented and checked whether not it has reached or surpassed the upper limit of retransmission attempts (S47). The upper limit of retransmission attempts here is a fixed value which does not vary during operation as indicated by the upper limit of retransmission attempts 80 in FIG. 7. If this checkup reveals that the retransmission counter is at a smaller count than the upper limit of retransmission attempts, the processing branches out to step 44 to process retransmission. If the retransmission counter is at a count not smaller than the upper limit of retransmission attempts, the processing branches out to step 48. At step 48, the Qdata is discarded, and the processing returns to step 41 to process Qdata transmission anew. In this way, by the CSMA/CA mechanism, control is performed within the upper limit of retransmission attempts, which is a fixed value, for any set of Qdata.

### Embodiment 1

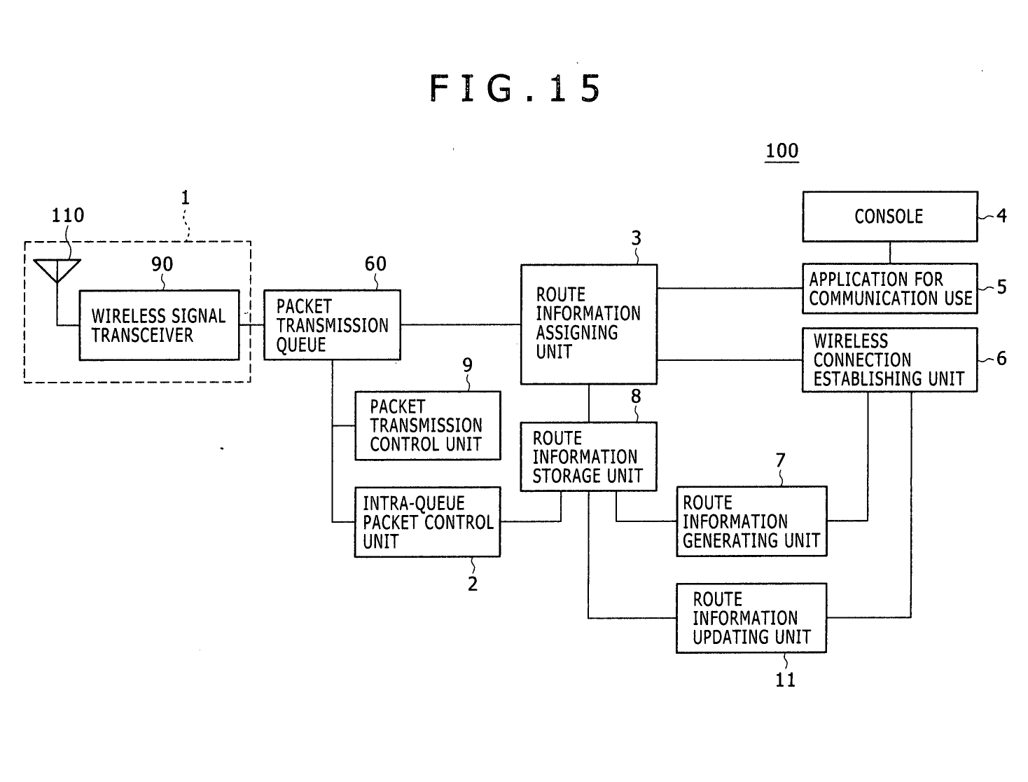

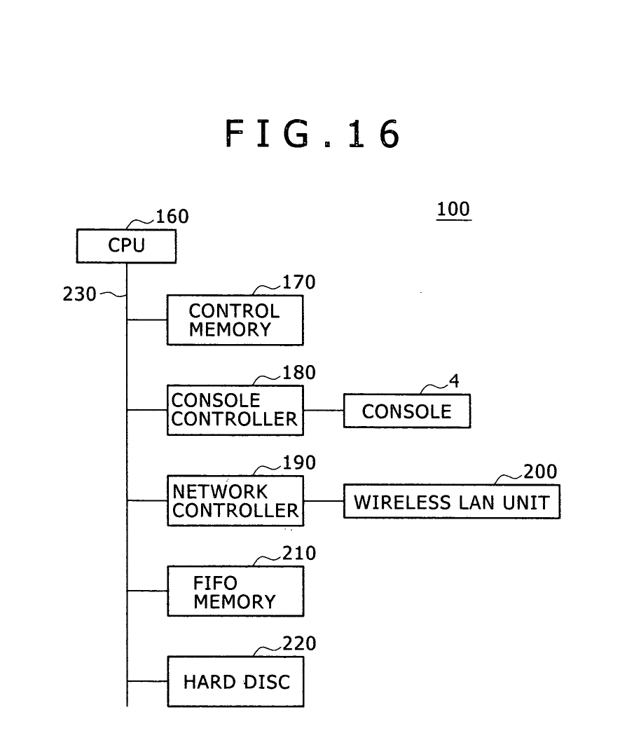

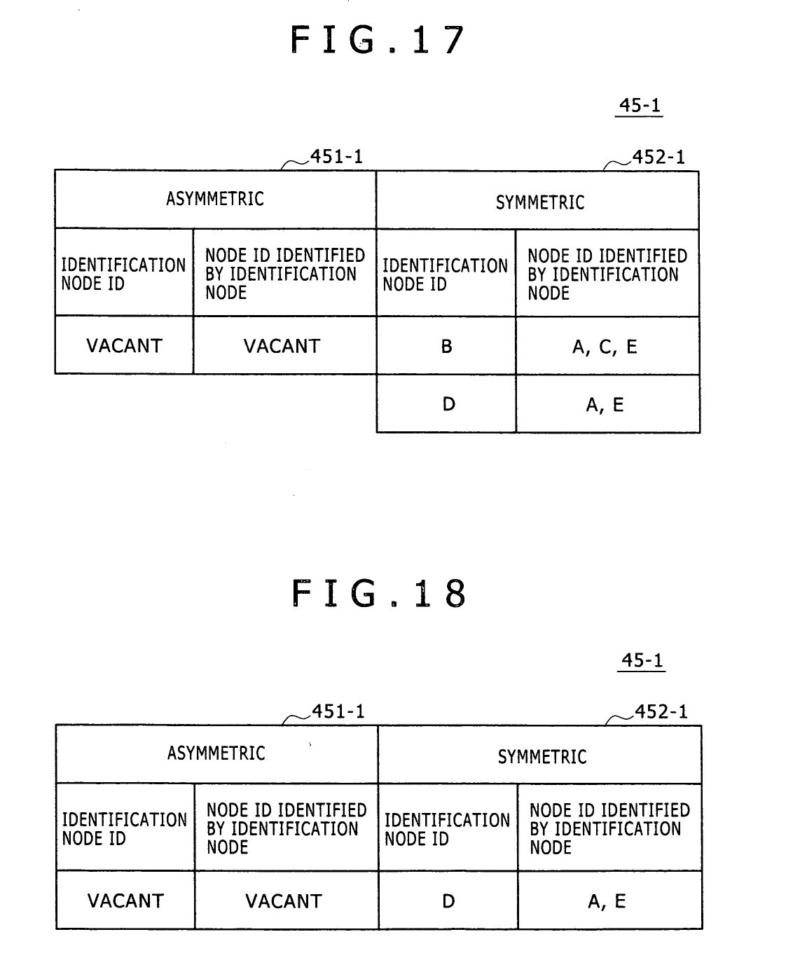

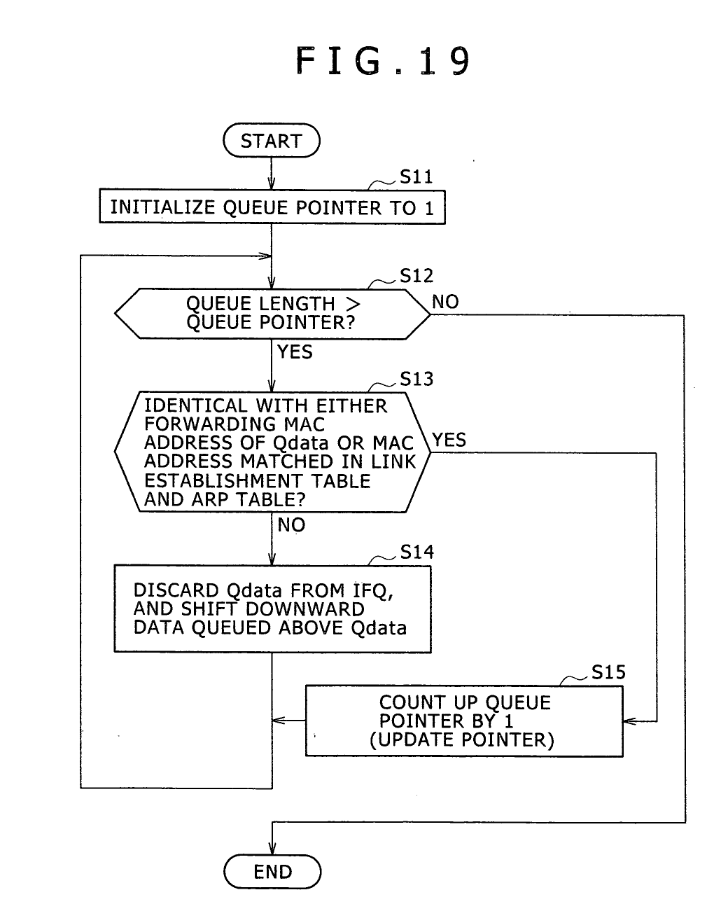

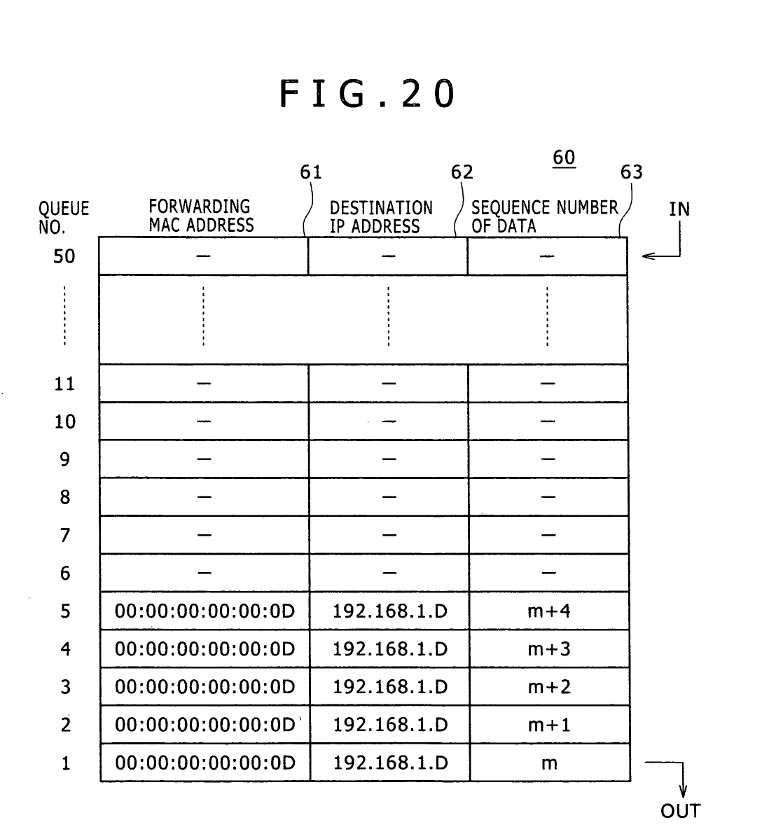

Embodiment 1 will be newly described below with reference to FIG. 15 through FIG. 20. FIG. 15 is a functional block diagram of a node. FIG. 16 is a hardware block diagram of the node. FIG. 17 and FIG. 18 illustrate the link establishment table of node A. FIG. 19 is a flowchart of processing of packet discarding. FIG. 20 illustrates the transmission queue of node A after the processing of packet discarding.

Referring to FIG. 15, a node 100 is configured of a wireless unit 1 including a wireless antenna 110 and a wireless signal transceiver 90, a packet transmission queue 60 which is a FIFO memory connected to the wireless unit 1, a packet transmission control unit 9 and an intra-queue packet control unit 2 connected to the packet transmission queue 60, a route information assigning unit 3 connected to the packet transmission queue 60, a route information storage unit 8 connected to the route information assigning unit 3 and the intra-queue packet control unit 2, a route information generating unit 7 connected to the route information storage unit 8, a route information updating unit 11 connected to the route information storage unit 8, a wireless connection establishing unit 6 connected to the route information assigning unit 3, the route information generating unit 7 and the route information updating unit 11, an application for communication use 5 connected to the route information assigning unit 3, and a console 4 connected to the application for communication use 5 and including a display unit and an input unit. Incidentally, FIG. 15 illustrates the transmitting function because the drawing is intended to help describe Embodiment 1.

The wireless unit 1 transmits and receives wireless signals. The packet transmission queue 60 is a FIFO memory which stores plural queues each including a forwarding MAC address, a destination IP address and the sequence number of data. The packet transmission control unit 9 transmits data from the packet transmission queue 60 to the wireless unit 1 under FIFO control. The intra-queue packet control unit 2, while referencing the route information storage unit 8, searches the plural queues stored in the packet transmission queue 60, and executes deletion of a queue meeting the search conditions or updating of the forwarding MAC address of a queue meeting the search conditions. The route information storage unit 8 stores a routing table, an ARP table and a number of retransmission attempts table. The wireless connection establishing unit 6 achieves link establishment and link severance by transmitting or receiving HELLO messages. The wireless connection establishing unit 6 also holds a link establishment table. The route information assigning unit 3, referencing the route information storage unit 8 assigns a forwarding MAC address to a packet to be transmitted. The route information assigning unit 3 also deletes the MAC address from a received packet, and transfers that packet to the application for communication use 5. Te route information generating unit 7, based on information contained in the HELLO packet received from the wireless connection establishing unit 6, generates information within the route information storage unit 8. The route information updating unit 11, based on information contained in the HELLO packet/timeout information received from the wireless connection establishing unit 6, updates information within the route information storage unit 8.

Referring to FIG. 16, the node 100 is configured of a central processing unit (CPU) 160, a controller memory 170, a console controller 180, the console 4 connected to the console controller 180, a network controller 190, a wireless LAN unit 200 connected to the network controller 190, a FIFO memory 210, a hard disk 220, and a bus 230 which connects the CPU 160, the controller memory 170, the console controller 180, the network controller 190, the FIFO memory 210 and the hard disk 220. As is noticed by comparing FIG. 16 with FIG. 15, the network controller 190 and the wireless LAN unit 200 constitute the wireless unit 1. Similarly, the FIFO memory 210 constitutes the packet transmission queue 60. The console 4 is a terminal for performing inputting and outputting vis-a-vis the user, and the console controller is its interface. The CPU 160 reads into the controller memory 170 plural programs recorded in the hard disk 220 and executes the plural programs. The controller memory 170 stores the plural programs, the routing table 40, the ARP table 50, the link establishment tables 45 and so forth. Other functional blocks shown in FIG. 15 than the wireless unit 1, the packet transmission queue 60 and the console 4 are achieved as programs to be executed by the CPU 160. Incidentally, instead of using the FIFO memory 210 as such, FIFO may be realized on the controller memory 170.

Now a case is supposed in which a data transfer from node A to node C and a data transfer from node A to node D are taking place at the same transmission rate within the same period in a state in which the network topology is configured as shown in FIG. 1 and each node has its link established. Then the link establishment table of node A is as shown in FIG. 17. Thus, the link establishment table 45-1 of node A is composed of an asymmetric column 451-1 and a symmetric column 452-1, and every box in the asymmetric column 451-1 is vacant. On the other hand, the ID of node B and the ID of node D are recorded in the identification node ID boxes of the symmetric column 452-1, and the node IDs of nodes A, C and E are recorded in the node ID box identified by the identification node of the identification node B. At the same time, the node IDs of nodes A and E are recorded in the node ID identified by the identification node of the identification node D.

If the network topology changes from the state of FIG. 1 to that of FIG. 3 via that of FIG. 2, node A will recognize link severance from node B. The link establishment table of node A after the link severance will be like FIG. 18, wherein node B is deleted. A description of FIG. 18 is dispensed with. At the timing of recognizing this link severance, the routing layer recognizes the transmission queue and discards data which need not be transmitted. The operations from this link severance recognition to data discarding will be newly described with reference to FIG. 19 and FIG. 20.

Now, FIG. 19 is a flowchart to describe the selection of the packet to be discarded and the processing to discard the packet. FIG. 20 illustrates the transmission queue after the processing of packet discarding.

First, FIG. 12 shows the transmission queue of node A immediately after link severance between node A and node B. Since node A here is transferring data to node C and node D, five sets each of data destined for node C and node D are alternately queued in the transmission queue.

Referring to FIG. 19, first the queue pointer is initialized (the queue pointer is set to 1) (S11). Next at 1-2, it is determined whether or-not the queue pointer is longer than the queue length (S12). Step 12 is performed to check whether or not the subsequent processing has been performed for all the sets of data in the transmission queue. If the determination at step 12 is negative, the processing is ended. On the other hand, if the determination at step 12 is affirmative, it is determined with reference to the ARP table whether or not the forwarding MAC address of the set of data which the queue pointer is pointing at (hereinafter referred to as Qdata) matches the MAC address of any node present in the link establishment table (S13). If it does not match the MAC address of any link-established node (NO), after discarding Qdata, the data in the transmission queue is shifted to fill vacancies in the transmission queue (S14), and the processing returns to step 12. If YES at step 13, the queue pointer is updated (S15), and the processing shifts to step 12.

After the completion of this packet discarding, the data within the transmission queue as shown in FIG. 12 is updated to that shown in FIG. 20. Incidentally, it is seen that the sets of data of queue numbers 1, 3, 5, 7 and 9 in FIG. 12 which were scheduled to be transferred to node C via node B have been discarded.

Since this embodiment makes dispensable the processing to retransmit data which need not be transmitted when the link is severed, the transmission throughput of data that requires transmission can be enhanced. As a result, the overall throughput of the network can be enhanced. Furthermore, as wasteful wireless transmission is restrained, power consumption by nodes can also be reduced.

### Embodiment 2

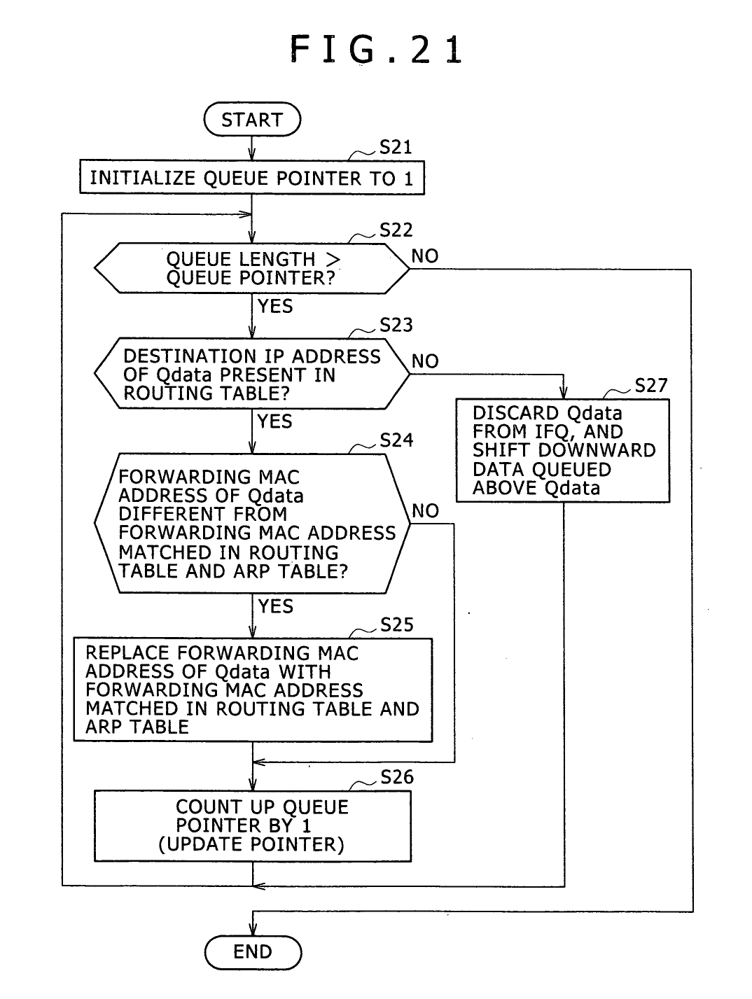

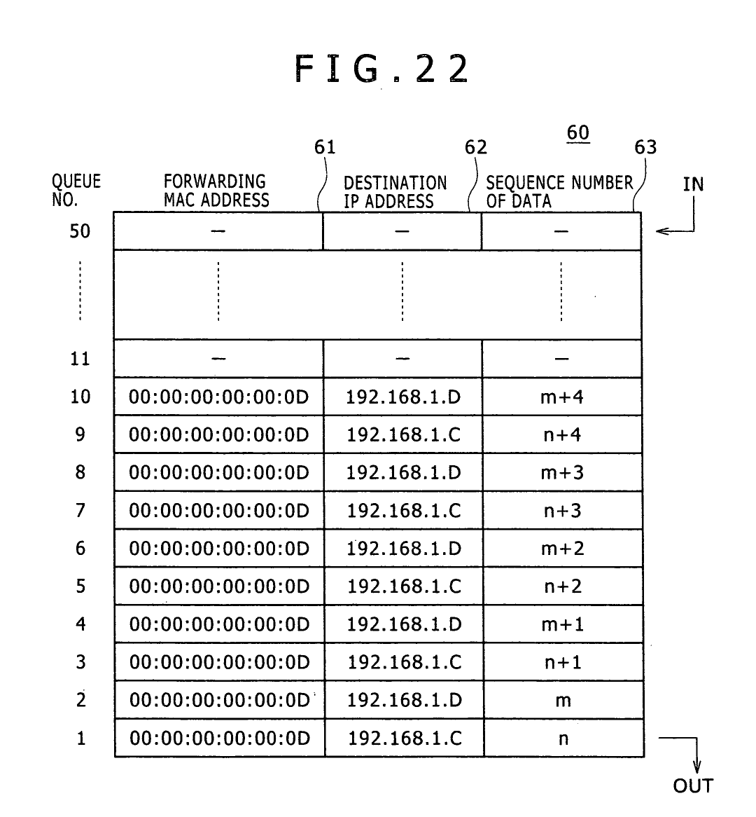

Embodiment 2 will now be newly described with reference to FIG. 21 and FIG. 22. FIG. 21 here is a flowchart of rerouting, and FIG. 22 illustrates the transmission queue of node A after the rerouting.

When the network topology changes from the state of FIG. 1 to that of FIG. 3 via that of FIG. 2, the routing table of node A is switched over from that of FIG. 9 to that of FIG. 11. In Embodiment 2, the routing layer confirms the transmission queue at the ting of this switch-over of the routing table, and the queued data is rerouted.

Referring to FIG. 21, first the queue pointer is initialized (S21). Next, it is determined whether or not the queue pointer is longer than the queue length (S22), and if NO, the processing is ended. If YES at step 22, it is determined whether or not the forwarding IP address of Qdata is present in the routing table (S23). If YES at step 23, in order to check whether or not the data awaiting transmission within the transmission queue is consistent with the latest routing information, the forwarding MAC address of Qdata and the destination IP address of Qdata are compared with the forwarding MAC address matched by the routing table and the ARP table to determine whether or not they are different (S24). If determined different (YES) at step 24, the forwarding MAC address of Qdata is replaced with the forwarding MAC address matched by the routing table and the ARP table (S25), the queue pointer is updated (S26), and the processing shifts to step 22. If determined not different (NO) at step 24, it means that Qdata is consistent with the latest routing information, and accordingly the processing shifts to step 26 without altering Qdata in any way.

On the other hand, if NO at step 23, Qdata is discarded, and the data in the transmission queue are shifted to fill vacancies in the transmission queue (S27). In this case, since the transmission queue is shifted, the processing shifts to step 22 without updating the queue pointer.

After completing this rerouting, the data in the transmission queue is updated from that shown in FIG. 12 to that shown in FIG. 22, and a transfer on a new route of node A→node D→node E→node F→node C is made possible without discarding data of n to n+4 in sequence number. Further, Qdata which was scheduled to be transferred to node D from the outset is not made later in transmission than before the execution of this processing, but can be made rather earlier by the reduction in retransmission of Qdata destined for node C.

Since this embodiment makes dispensable the processing to retransmit data which need not be transmitted when the routing table is updated, the transmission throughput of data that requires transmission can be enhanced. By rerouting the data transfer at the time of updating the routing table, the data is enabled to be transferred on an altered route without being discarded, and accordingly the time taken to retransmit the data which otherwise would have been discarded is eliminated. As a result, the overall throughput of the network can be enhanced. Furthermore, as wasteful wireless transmission is restrained, power consumption by nodes can also be reduced.

### Embodiment 3

A case is supposed here in which a data transfer from node A to node C and a data transfer from node A to node D are taking place at the same transmission rate within the same period in a state in which the network topology is configured as shown in FIG. 1 and each node has its link established. Then the link establishment table of node A is as shown in FIG. 17.

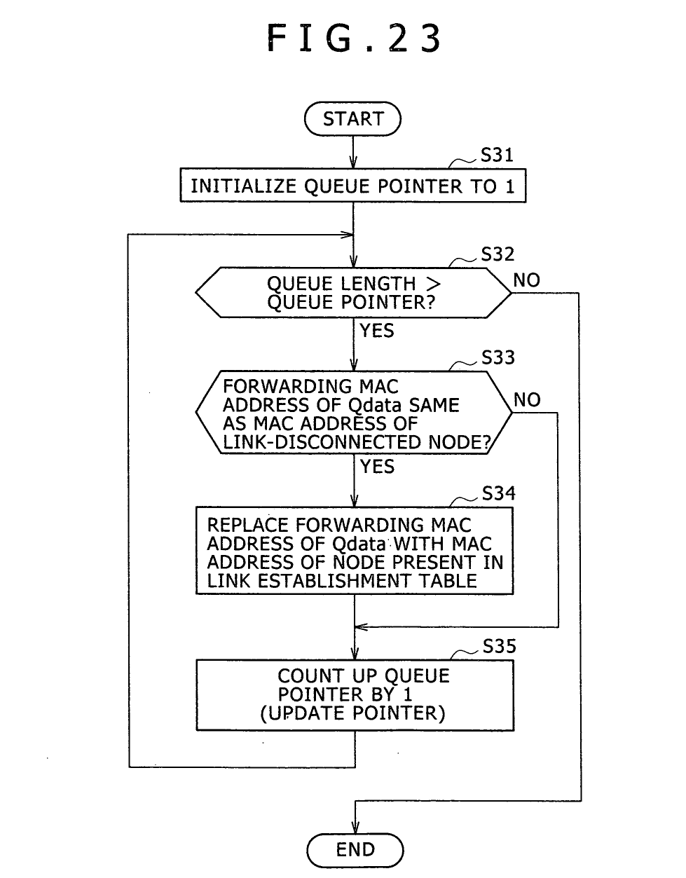

When the network topology changes from the state of FIG. 1 to that of FIG. 3 via that of FIG. 2, node A will recognize link severance from node B. The link establishment table of node A after the link severance will be like FIG. 18, wherein node B is deleted. In this embodiment, at the timing of recognizing this link severance, the routing layer recognizes the transmission queue and replaces the forwarding MAC address of data which need not be transmitted with the MAC address of a link-established node. Details of the operations from the recognition of this link severance to the replacement of the forwarding MAC address will be described with reference to FIG. 23. FIG. 23 here is a flowchart of rerouting.

Referring to FIG. 23, first the queue pointer is initialized (S31). Next, it is determined whether or not the queue pointer is longer than the queue length (S32). If NO at step 32, the processing is ended or if YES, the forwarding MAC address of the data the queue pointer is pointing at and the MAC address of the link-disconnected node that can be checked by referencing the ARP table are compared (S33). If these two are the same (YES), they can be determined to be data whose Qdata has no forwarding node; therefore, the MAC address of the node present in the link establishment table is extracted by referencing the ARP table, replaced with the forwarding MAC address of Qdata (S34), the queue pointer is incremented (S35), and the processing returns to step 32. If the two addresses are found different at step 33 (NO), the processing skips step 34 and branches out to step 35.

After the completion of this rerouting, the data in the transmission queue is updated from those in FIG. 12 to those in FIG. 22, and a transfer on a new route of node A→node D→node E→node F→node C is made possible without discarding data of n to n+4 in sequence number. Further, Qdata which was scheduled to be transferred to node D from the outset is not made later in transmission than before the execution of this processing, but can be made rather earlier by the reduction in retransmission of Qdata destined for node C.

Since this embodiment causes, when the link is severed, a packet intended for transmission to a node whose link is not established to reach a link-established node, the probability for the packet having reached the link-established node to pass another route and reach the destination node is increased. As a result, the number of attempts to retransmit the packet can be reduced, and enhancement of the overall throughput of the network can be expected.

### Embodiment 4

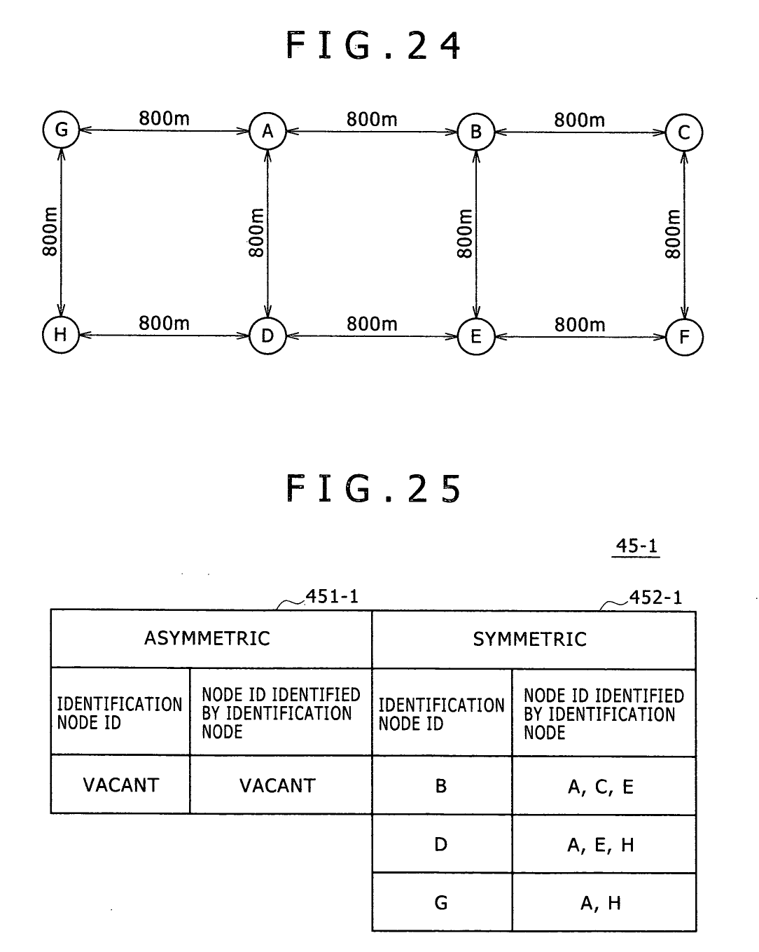

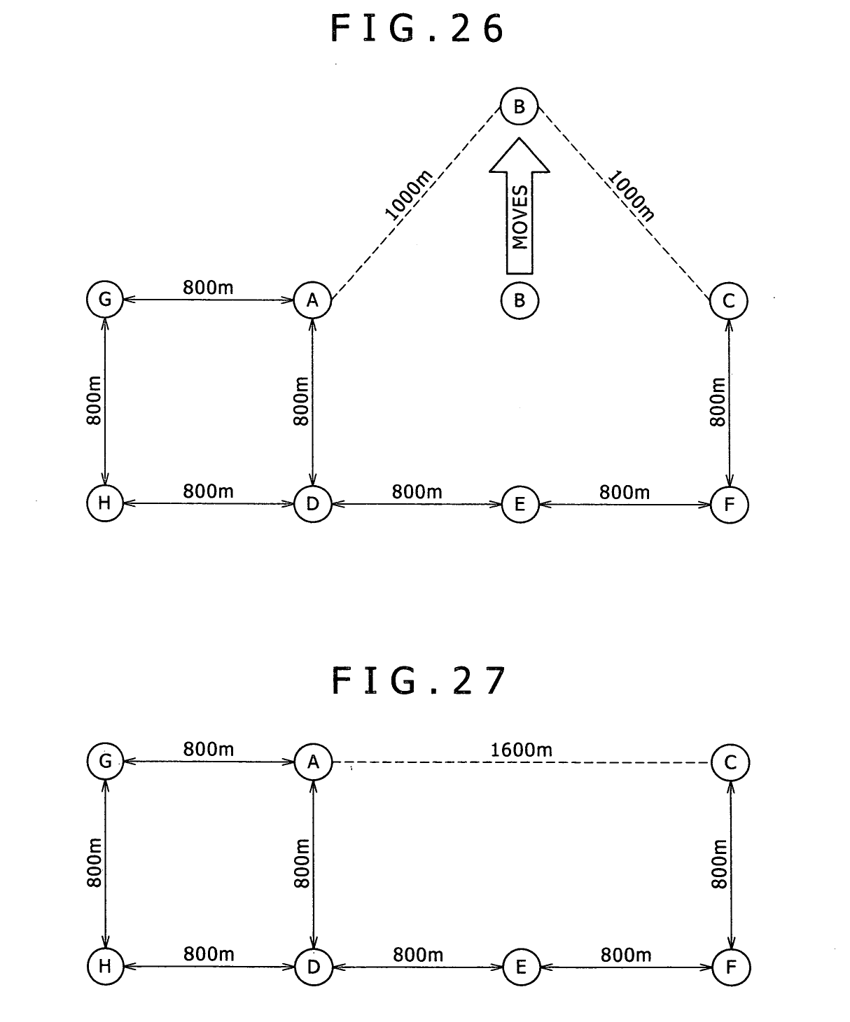

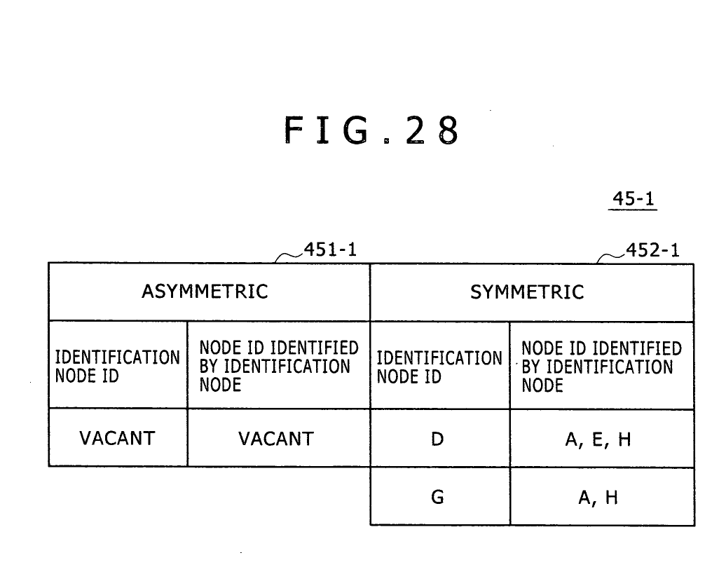

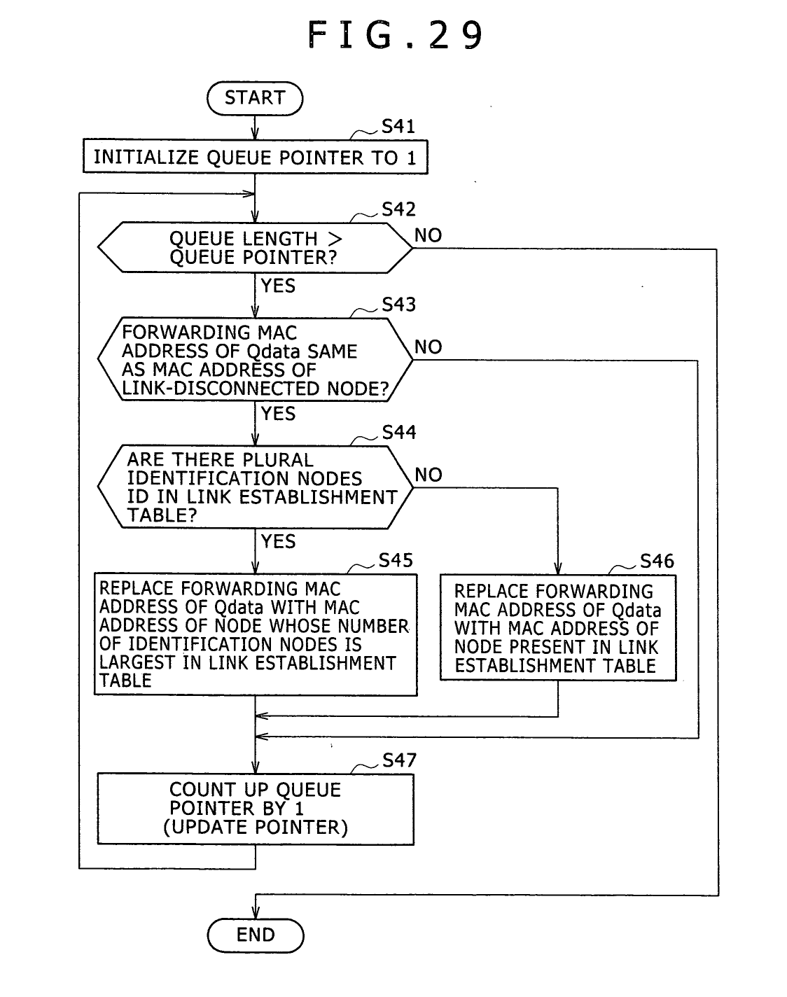

Embodiment 4 will be described with reference to FIG. 24 through FIG. 29. FIG. 24, FIG. 26 and FIG. 27 here illustrate network topologies. FIG. 25 and FIG. 28 illustrate the link establishment table of node A. FIG. 29 is a flowchart of rerouting.

A case is supposed here in which a data transfer from node A to node C and a data transfer from node A to node D are taking place at the same transmission rate within the same period in a state in which the network topology is configured as shown in FIG. 24 and each node has its link established. The preconditions are that the length of the transmission queue of each node is 50 and 10 sets of data on the average are queued in the transmission queue of node A during a data transfer period as data awaiting transmission. Further, the link establishment table of node A then is as shown in FIG. 25. Thus, the link establishment table 45-1 of node A is composed of an asymmetric column 451-1 and a symmetric column 452-1, and every box in the asymmetric column 451-1 is vacant. On the other hand, the ID of node B and the ID of node D are recorded in the identification node ID boxes of the symmetric column 452-1, and the node IDs of nodes A, C and E are recorded in the node ID box identified by the identification node of the identification node B. At the same time, the node IDs of nodes A, E and H are recorded in the node ID box identified by the identification node of the identification node D. Further, the node IDs of nodes A and H are recorded in the node ID identified by the identification node of the identification node G.

When the network topology changes from the state of FIG. 24 to that of FIG. 27 via that of FIG. 26, the routing table of node A recognizes severance of the link with node B. The link establishment table of node A after the link severance is as shown in FIG. 28, with node B deleted. In Embodiment 4, at the timing of recognizing this link severance, the routing layer recognizes the transmission queue and replaces the forwarding MAC address of data which need not be transmitted with the MAC address of the node with the greatest number of identification nodes among the link-established nodes. The operations from the recognition of this link severance to the replacement of the forwarding MAC address will be described below.

Referring to FIG. 29, first the queue pointer is initialized (S41). Next, it is determined whether or not the queue pointer is longer than the queue length (S42), and if NO, the processing is ended. If YES at step 42, the forwarding MAC address of Qdata and the MAC address of the link-disconnected node that can be checked by referencing the ARP table are compared (S43). If these two are found different (NO), it can be determined that Qdata is data having a forwarding node, and accordingly, the processing branches out to incrementing the queue pointer (S47). If the two addresses are found identical at step 43, it is determined whether or not there are plural identification nodes in the link establishment table (S44); if there is only one, the MAC address of the node present in the link establishment table is extracted by referencing the ARP table, its replacement with the forwarding MAC address of Qdata is processed (S46), and the processing shifts to step 47.

If at step 44 the presence of plural identification nodes is determined, the forwarding MAC address of Qdata is replaced with the MAC address of the node with the largest number of identification nodes among the identification nodes stored in the link establishment table (S45), and the processing shifts to step 47. At step 47, the queue pointer is updated, and the processing shifts to step 42.

Incidentally, step 44 through step 46 may as well be put together into a single step to replace the forwarding MAC address of Qdata with the MAC address of the node with the greatest number of identification nodes among the identification nodes stored in the link establishment table. This would result in substantially the same flow as what is charted in FIG. 23, described in connection with Embodiment 3.

After the completion of this rerouting, the data in the transmission queue is updated from those in FIG. 12 to that in FIG. 22, and a transfer on a new route of node A→node D→node E→node F→node C is made possible without discarding data of n to n+4 in sequence number. Further, Qdata which was scheduled to be transferred to node D from the outset is not made later in transmission than before the execution of this processing, but can be made rather earlier by the reduction in retransmission of Qdata destined for node C.

Since this embodiment causes, in the presence of plural link-established nodes when the link is severed, a packet to be transmitted to the selected node with the greatest number of link-established nodes among the link-established nodes, the probability for the packet to reach the destination node can be further increased. As a result, the number of attempts to retransmit the packet can be reduced, and enhancement of the overall throughput of the network can be expected.

### Embodiment 5

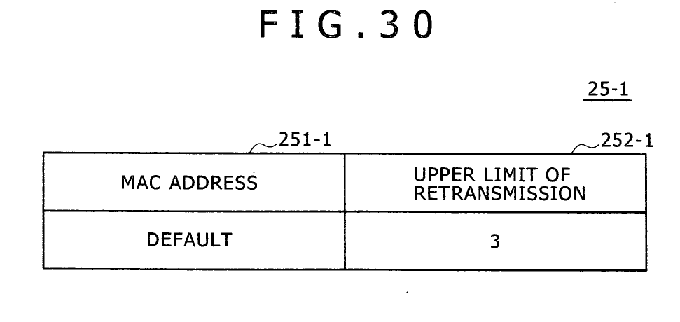

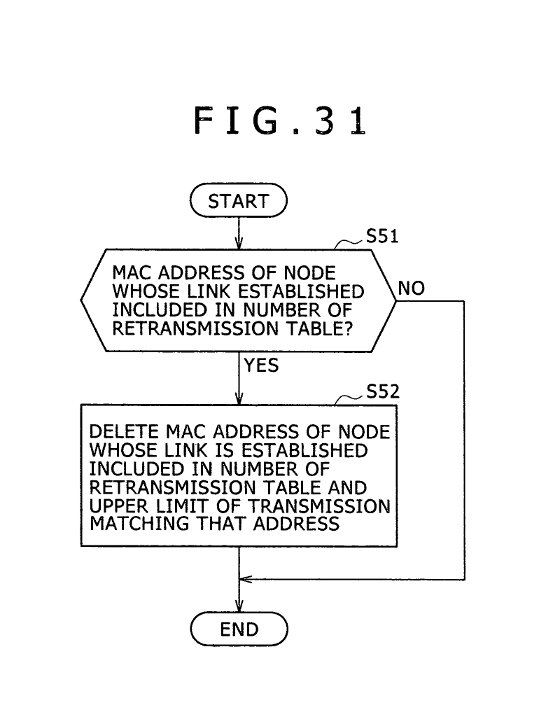

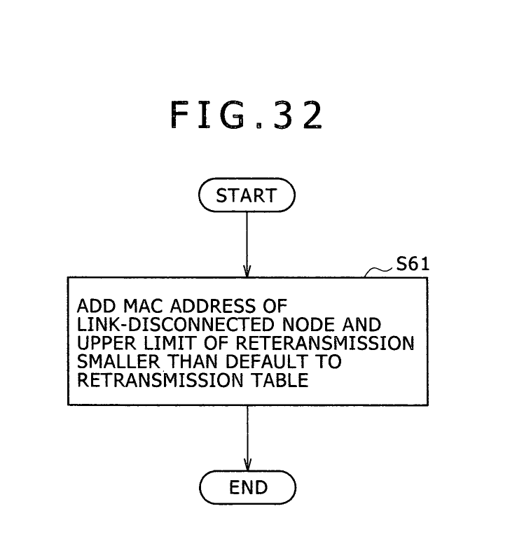

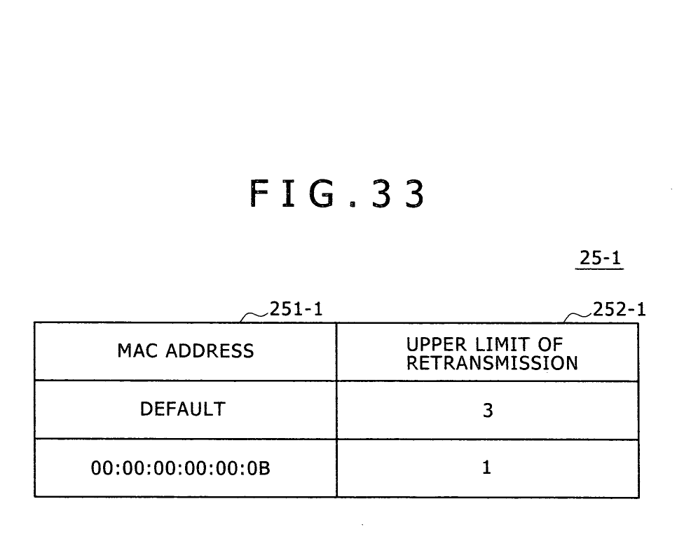

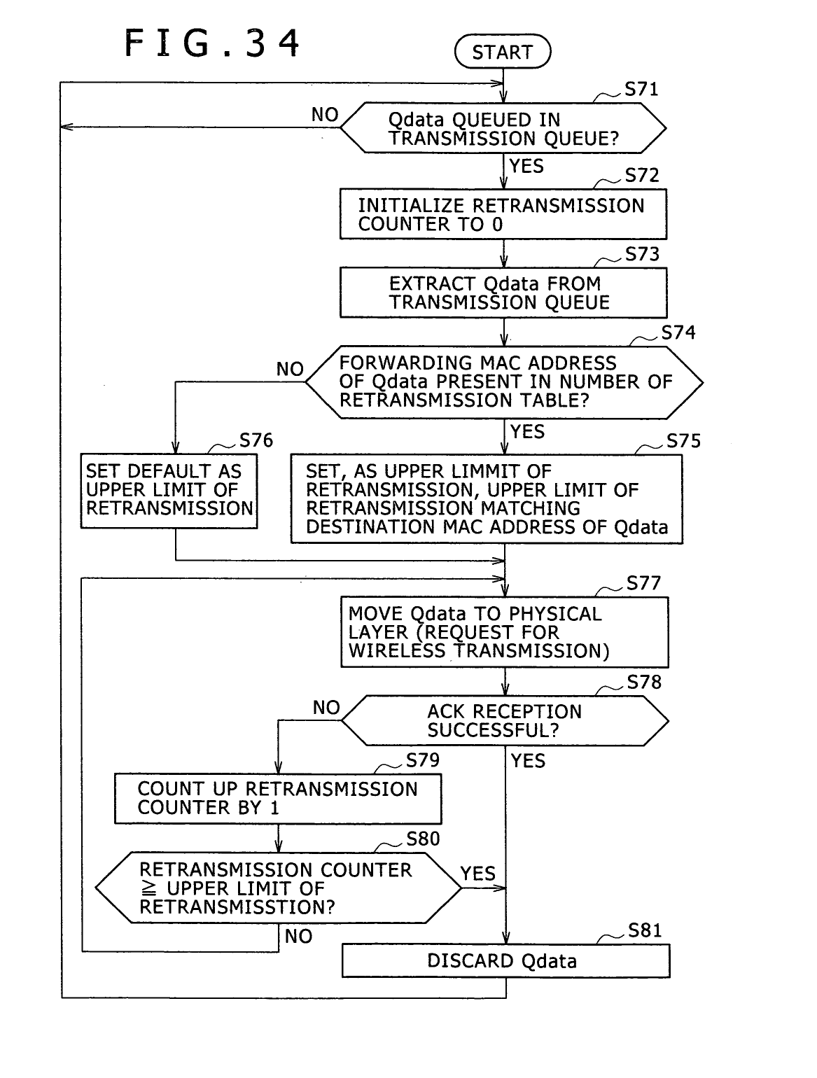

Embodiment 5 will be described with reference to FIG. 30 through FIG. 34. FIG. 30 and FIG. 33 here illustrate the number of retransmission attempts table. FIG. 31 is a flowchart of updating the number of retransmission attempts at the time of link establishment. FIG. 32 is a flowchart of updating the number of retransmission attempts at the time of link severance. FIG. 34 is a flowchart of operations to process packet transmission.

In the initial setting of the number of retransmission attempts, only the upper limit of retransmission attempts, which is the default, is set as shown in FIG. 30. Referring to FIG. 30, a number of retransmission attempts table 25-1 is composed of a MAC address column 251-1 and an upper limit of retransmission attempts column 252-1; the “default” entered in the MAC address column 251-1 indicates that 3, which is the default value of the upper limit of retransmission attempts, is set for every MAC address. Hereinafter this default value of the upper limit of retransmission attempts will be referred to as the upper limit of retransmission attempts D.

Next to describe the updating of the number of retransmission attempts table, first, there are two update timings, including the time of link establishment and that of link severance.

First, the operation to update the number of retransmission attempts at the time of link establishment will be described with reference to FIG. 31. First, it is determined whether or not the MAC address of a link-established node is contained in the number of retransmission attempts table 25 (S51) and, if it is included (YES), the processing branches out to step 52. If it is not (NO), the processing ends. At step 52, the MAC address of the link-established node and the upper limit of retransmission attempts matching that address are deleted from the number of retransmission attempts table. Incidentally, regarding the foregoing description, reference is made to FIG. 33, which will be described afterwards as the number of retransmission attempts table 25.

Next, FIG. 32 shows a flowchart of updating the number of retransmission attempts at the time of link severance. At step 61, the MAC address of a link-disconnected node and the upper limit of retransmission attempts matched with that address are added to the number of retransmission attempts table. The upper limit of retransmission attempts added here is supposed to be a smaller value than the upper limit of retransmission attempts D, and this value will hereinafter be referred to as the upper limit of retransmission attempts S.

This processing will be described with reference to a specific example. First, the network topology is supposed to shift from that of FIG. 1 to that of FIG. 3 and to return that of FIG. 1. The number of retransmission attempts table in the state of FIG. 1 is the same as initial setting, as shown in FIG. 30. When the network topology changes from this state of FIG. 1 to that of FIG. 3, the number of retransmission attempts table will vary as shown in FIG. 33. Thus, as described with reference to FIG. 32, the MAC address of link-disconnected node B is added to the MAC address column 251-1, and “1” is selected at the upper limit of retransmission attempts S to be entered into the upper limit of retransmission attempts column 252-1. When the network topology has returned to the state of FIG. 1, the number of retransmission attempts table will return to the state of FIG. 30 as described with reference to FIG. 31.

Next, the operation to alter the CSMA/CA mechanism of Embodiment 5 will be described with reference to FIG. 34. Referring to FIG. 34, first, it is checked whether or not Qdata is queued in the transmission queue 60 (S71). If it is not queued (NO), this means that there is no data to be transmitted, and therefore step 71 is repeated. If at step 71 it is found queued (YES), the retransmission counter is initialized to 0 (S72). Next, Qdata is extracted from the transmission queue 60 (S73). It is then checked whether or not the forwarding MAC address of extracted Qdata is present in the number of retransmission attempts table 25 (S74). If it is (YES), a value matched with that MAC address is set as the upper limit of retransmission attempts (S75). If at step 74 it is not found present (NO), the default value in the number of retransmission attempts table is set as the upper limit of retransmission attempts (S76).

Next, Qdata is handed over to the physical layer 150 (S77). Then, as the physical layer 150 wirelessly transmits Qdata to the opposite node, the transmitting node awaits ACK from the opposite node. Next, it is checked whether or not ACK has been successfully received (S78); if successful (YES), the held Qdata is discarded (S81), and the processing returns to step 71.

If unsuccessful at step 78 (NO), the retransmission counter is incremented for retransmission processing (S79), and it is checked whether or not the count of the retransmission counter is at or above the upper limit of retransmission attempts (S80). If at step 80 the count of the retransmission counter is below the upper limit of retransmission attempts (NO), the processing branches out to step 77 again to process retransmission. If at step 80 the count of the retransmission counter is at or above the upper limit of retransmission attempts (YES), the held Qdata is discarded (S81), and the processing returns to step 71.

A case is supposed here in which a data transfer from node A to node C and a data transfer from node A to node D are taking place at the same transmission rate within the same period in a state in which the network topology is configured as shown in FIG. 1 and each node has its link established. The preconditions are that the length of the transmission queue of each node is 50 and 10 sets of data on the average are queued in the transmission queue of node A during a data transfer period as data awaiting transmission. Further, the link establishment table of node A then is as shown in FIG. 17.

When the network topology is as shown in FIG. 1, if the number of retransmission attempts table is as shown in FIG. 30 as described above and the transmission queue is as shown in FIG. 12, the number of retransmission attempts of all the sets of Qdata in the transmission queue is three, which is the default. Then, when the state has shifted from that of FIG. 1 to that of FIG. 3, as the number of retransmission attempts table is as shown in FIG. 33, the maximum number of retransmission attempts of Qdata whose forwarding MAC address is “00:00:00:00:00:0B” will be one if the transmission queue then is as shown in FIG. 12. The maximum number of retransmission attempts of any other forwarding MAC address (“00:00:00:00:00:0D” in FIG. 12) of Qdata is three.

This processing makes it possible to reduce only the number of retransmission attempts of data in the transmission queue of which a link-disconnected node is the destination.

This embodiment can help reduce wasteful wireless transmission attempts to nodes having no link establishment. As a result, the overall throughput of the network can be enhanced. Furthermore, as wasteful wireless transmission is restrained, power consumption by nodes can also be reduced.

According to the present invention, a wireless communication apparatus for network use, which is simple and capable of improving the quality of communication, can be provided.

What is claimed is:

1. A wireless communication apparatus, comprising:
a wireless unit that transmits and receives wireless signals including packets;
a wireless connection establishing unit that determines establishment or severance of wireless connection with another wireless communication apparatus arranged within the reach of wireless signals;
a routing information generating unit that generates transfer routing information for packets; and a packet transmission queue that holds queues containing forwarding MAC addresses, further provided with:
an intra-queue packet control unit that, when said wireless connection establishing unit has determined the severance of wireless connection, searches for the presence or absence of any queue which is held by said packet transmission queue and of which said wireless connection is to be severed.

2. A wireless communication apparatus, comprising:
a wireless unit that transmits and receives wireless signals including packets;
a wireless connection establishing unit that determines establishment or severance of wireless connection with another wireless communication apparatus arranged within the reach of wireless signals;
a routing information generating unit that generates transfer routing information for packets; and a packet transmission queue that holds queues containing forwarding MAC addresses, further provided with:
an intra-queue packet control unit that, when said wireless connection establishing unit has determined the severance of wireless connection, deletes any queue which is held by said packet transmission queue and of which said wireless connection is to be severed, said routing information generating unit updating said transfer routing information.

3. A wireless communication apparatus, comprising:
a wireless unit that transmits and receives wireless signals including packets; a wireless connection establishing unit that determines establishment or severance of wireless connection with another wireless communication apparatus arranged within the reach of wireless signals;
a routing information generating unit that generates transfer routing information for packets; and a packet transmission queue that holds queues containing forwarding MAC addresses, further provided with:
an intra-queue packet control unit that, when said wireless connection establishing unit has determined the severance of wireless connection, updates on the basis of updated transfer routing information the forwarding MAC address of any queue which is held by said packet transmission queue and of which said wireless connection is to be severed, said routing information generating unit updating said transfer routing information.

4. A wireless communication apparatus, comprising:
a wireless unit that transmits and receives wireless signals including packets;
a wireless connection establishing unit that determines establishment or severance of wireless connection with another wireless communication apparatus arranged within the reach of wireless signals;
a routing information generating unit that generates transfer routing information for packets; and a packet transmission queue that holds queues containing forwarding MAC addresses, further provided with:
an intra-queue packet control unit that, when said wireless connection establishing unit has determined the severance of wireless connection, updates the forwarding MAC address of any queue which is held by said packet transmission queue and of which said wireless connection is to be severed into a MAC address for which wireless connection is established, said routing information generating unit updating said transfer routing information.

5. The wireless communication apparatus according to claim 4, wherein:
in the presence of a plurality of MAC addresses for which said wireless connection is established, updating is accomplished to a MAC address of a wireless apparatus having the greatest number of wireless apparatuses recognized by the wireless apparatus having a MAC address for which said wireless connection is established.

6. A wireless communication apparatus, comprising:
a wireless unit that transmits and receives wireless signals including packets;
a wireless connection establishing unit that determines establishment or severance of wireless connection with another wireless communication apparatus arranged within the reach of wireless signals;
a routing information generating unit that generates transfer routing information for packets; and a packet transmission queue that holds queues containing forwarding MAC addresses,
wherein the upper limit of retransmission attempts of the packet whose destination is a severed wireless terminal held by said packet transmission queue is reduced when said wireless connection establishing unit has determined the severance of wireless connection.

7. A wireless communication apparatus, comprising:
a central processing unit connected by a bus;
a control memory into which a plurality of programs are written;
a network controller;
a FIFO memory that holds transmission queues each containing transfer MAC addresses and destination IP addresses; and
a wireless LAN unit connected to said network controller,
wherein when severance of the link with another wireless communication apparatus has been detected, said FIFO memory is searched with the IP address of said other wireless communication apparatus as a key, and any queue destined for said other wireless communication apparatus is discarded or updated.

8. A wireless communication apparatus comprising:
a central processing unit connected by a bus;
a memory;
a network controller; and
a wireless LAN unit connected to said network controller,
wherein said memory has a control area in which a plurality of programs are written; and a FIFO area that holds transmission queues each containing transfer MAC addresses and destination IP addresses, and
when severance of a link with another wireless communication apparatus has been detected, said FIFO area is searched with the IP address of said other wireless communication apparatus as a key, and any queue destined for said other wireless communication apparatus is discarded or updated.
